(19) United States
(12) Patent Application Publication
(10) Pub. No.: US 2019/0274338 A1
(43) Pub. Date: Sep. 12, 2019

(54) Simplified Method of Cooking Salmon Using Boiling Water

(71) Applicants: Robert J. Warner, Lunenburg (CA); Douglas B. Hall, Newtown, OH (US); Scott Brown, Acton (CA)

(72) Inventors: Robert J. Warner, Lunenburg (CA); Douglas B. Hall, Newtown, OH (US); Scott Brown, Acton (CA)

(21) Appl. No.: 16/300,155

(22) PCT Filed: May 10, 2017
(86) PCT No.: PCT/CA2017/000122

§ 371 Date: Nov. 9, 2018

Related U.S. Application Data
(60) Provisional application No. 62/333,904, filed on May 10, 2016.

(51) Int. Cl. A23L 5/10; A23B 4/08; A23L 17/00

(52) U.S. Cl. CPC A23L 5/13; A23V 2002/00; A23L 17/00; A23B 4/08

(57) ABSTRACT

A simplified method of cooking salmon uses boiling water as it cools to cook the fish, includes the following steps: providing a frozen fillet of fish in a sealed bag; placing the bag in a container holding boiling water and simultaneously or immediately thereafter removing heat or an energy source; retaining the bag in the water for a period of time; removing the bag from the water; delaying removal of the fish from the bag for an additional period of time; then removing the fish from the bag for consumption. A kit includes the frozen fish fillet in the bag along with instructions to follow the method of cooking.

### CROSS REFERENCE TO RELATED APPLICATION

This application claims the benefit of application No. 62/333,904 filed on May 10, 2016 which is hereby incorporated herein by reference in its entirety.

### FIELD OF THE INVENTION

The present invention relates generally to cooking, particularly cooking fish and seafood.

### BACKGROUND OF THE INVENTION

It is often perceived as difficult for consumers to cook salmon and similar fish effectively at home. Traditional cook methods, if not followed to the letter, can lead to a less than ideal cooked product. There are known methods of cooking that have attempted to solve this problem, but there still exists a need for an improved method of cooking salmon given that current known methods are deficient and commonly result in less than ideally cooked product.

U.S. Pat. No. 6,637,939 discloses cooking food in bag. The present invention is different because while the cited patent requires a bag with a steam vent due to direct cooking exposure, the present invention does not require same, nor does the cited patent include reference or suggestion of desired cooking times and parameters.

The present invention may be utilized to improve the cooking of salmon and other fish and seafood and to solve other problems not expressly identified or contemplated by the prior patents identified above.

### SUMMARY OF THE INVENTION

In accordance with an aspect of the invention, a method of cooking salmon or the like is provided comprising the following steps: providing a frozen fillet of fish in a sealed bag suitable for cooking in boiling water; providing a cooking container including water therein and applying sufficient heat or energy source to the container in order to bring water to a boil; placing said bag in boiling water and simultaneously or immediately thereafter remove heat or energy source; retaining the bag in water for a period of time, for example, 10 minutes; removing the bag from water, optionally delaying removal of fish from bag for an additional period of time, for example 1 to 3 minutes; removing fish from bag for consumption.

### DESCRIPTION OF THE DRAWINGS

Reference will now be made, by way of example, to the accompanying drawings which show example embodiments, and in which:

FIG. 1 is a comparison of End Cook Temperatures;

FIG. 2 is a comparison of cook time between Sauce vs No Sauce and Score vs No Score;

FIG. 3 is a comparison of cook time between 20 mm and 22 mm thick cut;

FIG. 4 is a comparison of cook time between different types of cuts;

FIG. 5 is a comparison of cook time between different coatings;

FIG. 6 is a comparison of cook time relative to the amount of water per fish;

FIG. 7 shows the time required to reach 145° F. relative to thickness of salmon.

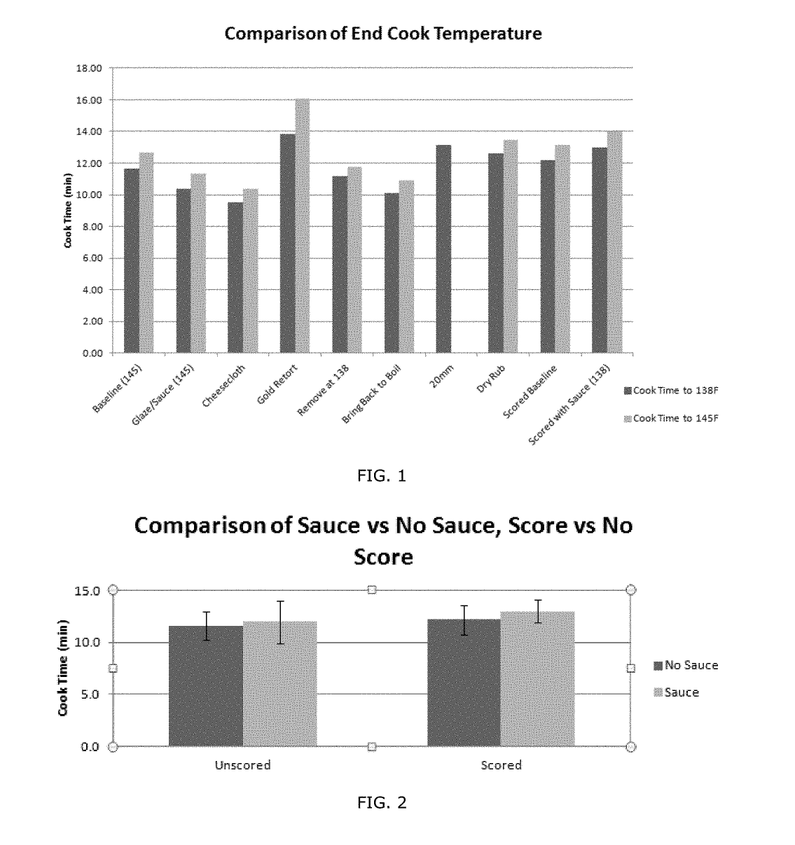

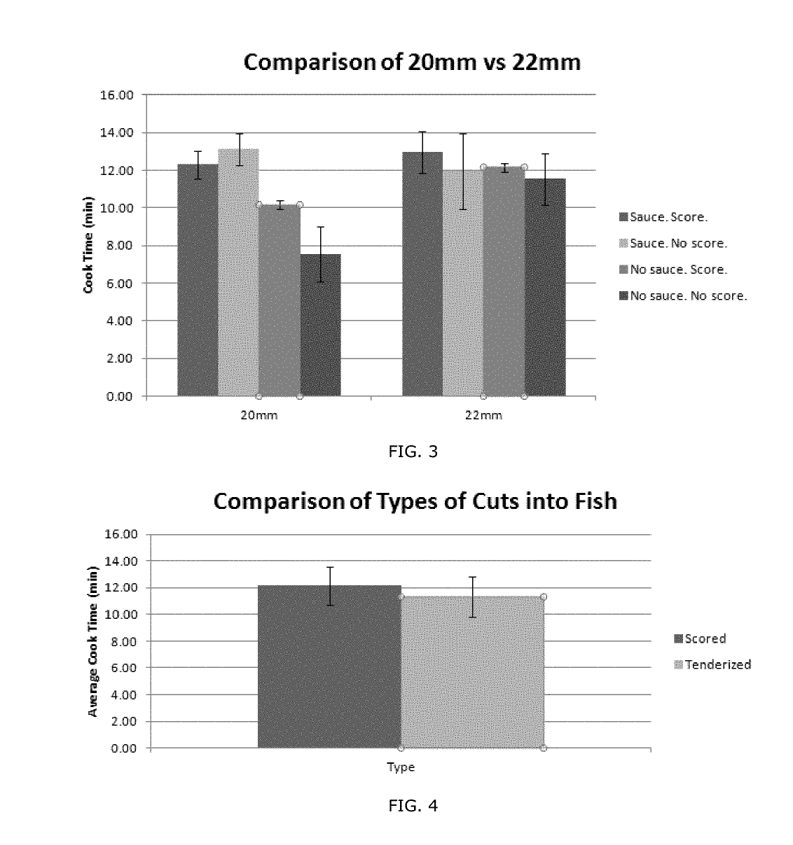

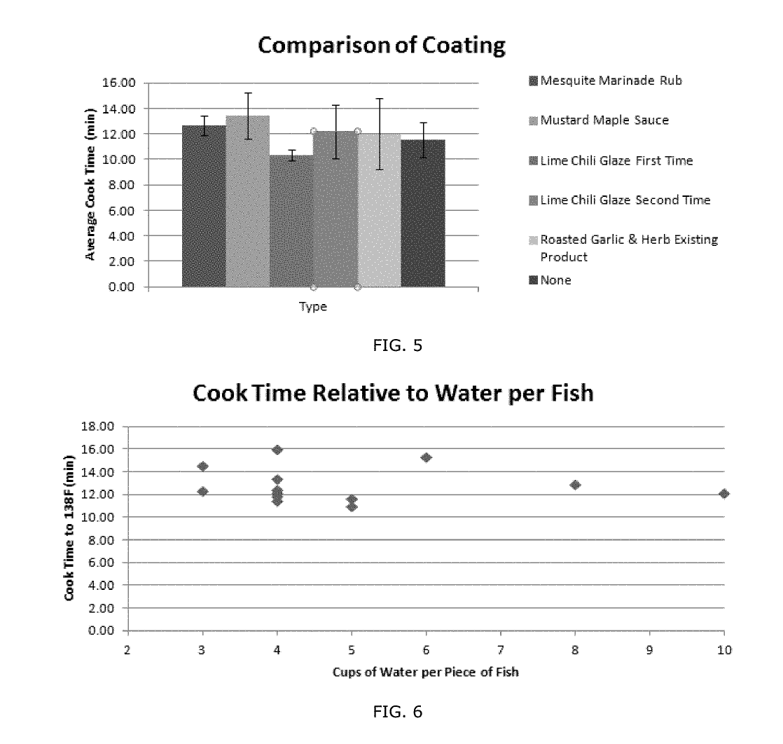

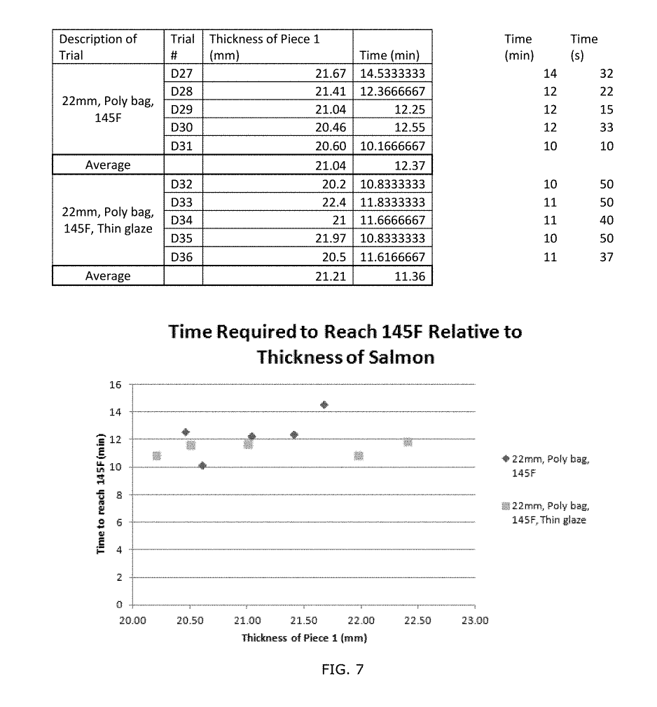

### DETAILED DESCRIPTION OF THE INVENTION

The present invention is a process or method of cooking fish. As discussed below and exemplified through extensive testing, the herein invention's example method will maximize the likelihood of a properly cooked product, with reduced likelihood of cooking error, resulting in “restaurant quality” cooked salmon or other fish such as, for example, trout, char, grayling and whitefish or other fish not expressly listed herein. It is intended that this process may be utilized for all species of fish, including but not limited to those listed above. The process allows for cooking in an acceptable time period for consumers. In accordance with an example embodiment of the invention, a process is defined as follows:

Provide a cooking vessel; bring water to a boil in a cooking vessel (by applying heat or via microwave or other energy source); provide a piece of frozen salmon or any suitable fish within a bag suitable for cooking in boiling water; seal the bag; place the bag into the cooking vessel containing the boiling temperature water, immediately turn off heat source, cover the cooking vessel, leave the bag submerged in the water for a set time period, remove bag from water, optionally delay removing fish from bag for further period of time, then remove salmon or other fish from the bag. The salmon or other fish is then ready to eat.

This example method was shown to have favorable cooking results. It was observed during testing that the placement of frozen fish into boiling temperature water, which then was removed from heat/energy source and allowed to cool, caused the appropriate level of cooking for fish, while not allowing vapor pressure inside the bag to exceed levels that could compromise the bag.

In the context of prior art fish cooking techniques, it is not known and would be counter intuitive to turn off the heat source while cooking fish as conventionally followed methods of cooking fish teach that heat must be applied consistently to fish to ensure thorough and proper cooking. As will be discussed below, based on extensive testing, factors such as the ratio of fish to water, thickness of fish, temperature of fish, time leaving cooking bag with fish in previously boiled cooling water, time before fish is removed from the bag after removal from water, were determinative of ideal cooking results.

### Example Testing and Data

Based on testing conducted in connection with the development of the herein invention, the data and results of which are discussed below and set out in schedule A, the inventive and advantageous preparation and cooking parameters of the herein invention were shown.

In an example embodiment of the invention, the salmon or other fish fillets (which may be also referred to interchangeably as pieces or fillets) were placed in bags having wall thickness of 90 microns/3.5 mil or 125 microns/5 mil comprising nylon EVOH enhanced linear low density polyethylene (coextrusion of polyolefin plastomer) with percentage composition nylon/evoh of 33%, bulk layers 32.5%, sealant 34.5% by weight. An example embodiment is the 23/08/99 MB-L or MB-I series of bag product offered by Winpak Ltd., based in Winnipeg, Manitoba, Canada, suitable for boiling. It should be understood that any known bag suitable and approved for use in cooking with boiling water may be used in accordance with the invention. In accordance with an aspect of the invention, the fillets are vacuum sealed in the bag.

In accordance with a further aspect of the invention, the above described bags are formed with an easy peel tap and a string that would allow the consumer to easily remove the bag from the pot and product from the bag after cooking. In accordance with a further aspect of the invention, the packaging film such as described above or other known or suitable packaging composition will be formed to embed a peel tab within the film that forms the bag envelope at location of a bag opening such that a peel tab is formed across bag openings along with a string extending from the tab to allow access to the consumer to activate the pull tab to open the bag.

While any suitable amount of water to allow the bag to be submerged may be used, in an example embodiment, the amount of water needed to boil 1-2 fillets is 8 cups. Based on testing, ideal cooking results were obtained with 8 cups of water per bag. Reference to cup is the conventional measure of a cup as 8 fluid ounces of water.

In accordance with an example embodiment of the invention, the water should be brought to a boil utilizing heat or other energy source in any known way prior to the frozen fillets being introduced to therein. The heat or energy source should be removed immediately after placing the bag(s) in the water. The bags with fillets therein should also remain submerged to the full extent possible as long as possible while in the water.

As set out in schedule A attached, approximately 235 cooking tests were undertaken to determine the effect of the relationships between:
a. Time
b. Temperature
c. Thickness and density of fish
d. Shape and cut of fish
e. Species of fish
f. Cooking vessel material and dimensions
g. Plastic film material, thickness, shape, format and composition
h. Water temperature
i. Water volume
j. Effect of the PH levels on heat transfer in seasoning applications (sauce, seasoning, marinate)

As shown by illustrative example in schedule A, products were tested by consumers and statistical scores were generated to measure cooking results based on consumer feedback. Data was collected on the above relationships, resulting in a conclusion reached regarding the advantageous optimum cooking parameters in accordance with an aspect of the invention. Testing revealed the following example preferred parameters resulting in favorable cooking results in accordance with an aspect of the invention:
1. Provide frozen fillet, preferably salmon at −18 degrees to −15 degrees Celsius within bag suitable for cooking in boiling water
2. Size of fillet 142 g (+/−13 g)
3. Thickness 2.5 cm (+/−0.5 cm)
4. Seal bag
5. Provide a cooking vessel and bring 8 cups of water to a boil.
6. Place bag, with frozen fish into boiling water, turn off heat and put cover on pot
7. Wait 10 minutes, remove bag from pot,
8. Wait for 2 minutes once removed from pot. Remove fish from pouch and enjoy.

It should be understood that favorable cooking parameters may also be achieved by varying the above example size, weight, time parameters observed in testing.

For example optimal cook results were observed with a max thickness of 22 mm for Atlantic Salmon and 26 mm for Pacific salmon.

In accordance with an aspect of the invention, the fillets could be treated in advance with flavorings and moisture enhancers as desired.

In accordance with an aspect of the invention, flavoring sauces may be included in the bag with fish fillet, however optimal results were observed when sauce mass does not exceed 20% of fish fillet weight.

In accordance with a further aspect of the invention, a kit may be provided to consumers comprising individually packaged frozen pieces of fish for example, in the preferred dimensions indicated above, or multiple individually bagged and packaged together and in an example embodiment preferably salmon is the fish presented. Instructions for cooking would be provided in the kit to follow a procedure, such as the methods described herein.

While this invention has been described in conjunction with the specific embodiments outlined above, it is evident that many alternatives, modifications and variations will be apparent to those skilled in the art. Accordingly, the example embodiments of the invention as set forth above are intended to be illustrative, not limiting. Various changes may be made without departing from the spirit and scope of the invention.

Schedule A
Work night Salmon

| Test number | RW 679-8 | |
|---|---|---|
| Date | Oct. 18/19, 2016 | |
| Hours logged | SR-3 hours | |
| Purpose of this test | To test if scoring the fish to a depth of 9 mm in a crossnaton | |
| | pattern, on both sides will shorten the cooking time. Previous | |
| | scoring test for reverse sous vide was not as deep. | |
| | Samples made with the salmon that | Line produced samples had sauce |
| | was brough in for the Aug 9 line | removed, thawed only as necessary |
| | produced product. | to allow scoring then reapplied |
| | | sauce and froze. |
| Raw material | Modified Chilean | Package |
| Code | | Pouch: Tiromat |
| Dimensions | 22 mm 4.5 oz | |
| Species | Atlantic | Packaging around tray |
| Glazed | yes (mustard) | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove after 12 mins | |
| Start Temp | −15 C. | |

| | Piece 1 | Piece 2 | Piece 3 | Piece 4 | Piece 5 | Piece 6 |
|---|---|---|---|---|---|---|
| Cook Time/Temp | 12 mins = | 12 mins = | 12 mins = | 12 mins = | 12 mins = | 12 mins = |
| | 128 | 105 | 131 | 94.9 | 112 | 101 |
| after additional hold | 2 mins = | 2 mins = | 2 mins = | 2 mins = | 2 mins = | 2 mins = |
| | 130 | 115 | 138 | 107 | 130 | 117 |
| Weight in (g) before sauce | 130.2 | 134.2 | 138.6 | 132.8 | 131.2 | 139.3 |
| Thickness (mm) before score | 21.5 | 23 | 21 | 22 | 24.5 | 24 |
| Width (mm) before score | 46 | 62 | 49 | 63 | 61 | 61 |
| Length (mm) before score | 167 | 116 | 166 | 118 | 122 | 140 |
| Weight with sauce | 163.3 | 163.5 | 174.1 | 162.5 | 157.4 | 167.4 |
| Observations | | | | This piece | | |
| | | | | under it's | | |
| | | | | floater | | |
| | | | | companion | | |
| | | | | #8 | | |
| Exudate amount (visual) | medium | medium | mild | mild | no | mild |

Exudate note - most of the exudate seemed to be near where temperature was tested, possibly
the exudate would have been less if fish had not been pierced
Score note - mostly not noticible except #8

| Next Steps | discontinue score tesing for reverse sous vide. | | | | All failed | |
|---|---|---|---|---|---|---|
| | Piece 7 | Piece 8 | Piece 9 | Piece 10 | Piece 11 | Piece 12 |
| Cook Time/Temp | 12 mins = | 12 mins = | 12 mins = | 12 mins = | 12 mins = | 12 mins = |
| | 133 | 117 | 134 | 109 | 127 | 124 |
| after additional hold | 2 mins = | 2 mins = | 2 mins = | 2 mins = | 2 mins = | 2 mins = |
| | 139 | 116 | 137 | 95 | 140 | 131 |
| Weight in (g) before sauce | 140.8 | 133.2 | 108.6 | 139.6 | 127.8 | 143.8 |
| Thickness (mm) before score | 22 | 21 | 21 | 21 | 21 | 22 |
| Width (mm) before score | 70 | 59 | 51 | 51 | 47 | 55 |
| Length (mm) before score | 136 | 165 | 123 | 172 | 161 | 167 |
| Weight with sauce | 169.3 | 168.1 | 133.1 | 172.5 | 157 | 174 |
| Observations | | Floated | | Dropped | | |
| | | slightly | | temp | | |
| | | Scores | | | | |
| | | very | | | | |
| | | visible | | | | |
| | | after | | | | |
| | | opening | | | | |
| Exudate amount (visual) | mild | mild | mild | yes, a | mild | no |
| | | | | lot on | | |
| | | | | one side | | |

Exudate note - most of the exudate seemed to be near where temperature was tested, possibly
the exudate would have been less if fish had not been pierced
Score note - mostly not noticible except #8

| | |
|---|---|
| Next Steps | not test 7 mm as |
| | 9 mm did not w |

| Test number | RW 674-108 | |
|---|---|---|
| Date | 13/10/2016 | |
| Hours logged | RW-1/4 | |
| Purpose of this test | Cooking line produced product from August 9 | |
| Raw material | Modified Chilean | Package |
| Code | | Pouch: Tiromat |
| Dimensions | 22 mm 4.5 oz | |
| Species | Atlantic | Packaging around tray |
| Glazed | yes (mustard) | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove after 12 mins | |
| Start Temp | −15 C. | |
| Cook Time/Temp | 12 mins = 141.2 | 12 mins = 133.3 |
| | +2 mins = 145.3 | +2 mins = 139.7 |
| | +4 min = 145.6 | +4 min = 140.7 |
| | Piece 1 | Piece 2 |
| Weight in (g) (w/ bag 7 g) | | |
| Weight out (g) (fish) = sauce | 157 | 127.6 |
| Yield (%) (fish) | #VALUE! | #VALUE! |
| Weight out (g) (fish + juice + | | |
| bag) | | |
| Yield (%) (fish + juice) | #VALUE! | #VALUE! |
| Thickness (mm) w/poly and gla [symbol] | 25 | 24.7 |
| Width (mm) w/poly and glaze | 57.1 | 76.1 |
| Length (mm) w/poly and glaze | 151.7 | 95.6 |
| Observations | sauce seems thinner | sauce seems thinner |
| Exudate amount (visual) | none | |
| Texture | #1 slight tough in places | |
| Fat between flakes | | |
| Pictures | no | |
| Logger | no | |
| Next Steps | | |
| Test number | RW 674-107 | |
| Date | 4/10/2016 | |
| Hours logged | RW-1/4 | |
| Purpose of this test | Cooking line produced product from August 9 | |
| Raw material | Modified Chilean | Package |
| Code | | Pouch: Tiromat |
| Dimensions | 22 mm 4.5 oz | |
| Species | Atlantic | Packaging around tray |
| Glazed | yes (mustard) | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove after 12 mins | |
| Start Temp | −15 C. | |
| Cook Time/Temp | 12 mins = 122.7 | 12 mins = 137.6 |
| | +2 mins = 131.9 | +2 mins = 143.6 |
| | +4 min = 134.2 | topped at 144 |
| | Piece 1 | Piece 2 |
| Weight in (g) (w/ bag 7 g) | 162.5 | 168.9 |
| Weight out (g) (fish) | | |
| Yield (%) (fish) | #VALUE! | #VALUE! |
| Weight out (g) (fish + juice + | | |
| bag) | | |
| Yield (%) (fish + juice) | #VALUE! | #VALUE! |
| Thickness (mm) w/poly and gla [symbol] | 25.8 | 25.2 |
| Width (mm) w/poly and glaze | 60.4 | 59.1 |
| Length (mm) w/poly and glaze | 149 | 147 |
| Observations | small bone | fat line slightly oxidized |
| | tougher piece of fish - when cooed at | good texture |
| | 134 F. | |
| Exudate amount (visual) | none | |
| Texture | #1 firm bite - good #2 soft & flaky | |
| Fat between flakes | | |
| Pictures | yes | |
| Logger | no | |
| Next Steps | | |
| Test number | RW 674-106 | |
| Date | 4/10/2016 | |
| Hours logged | RW-1/2 | |
| Purpose of this test | Cooking line produced product from August 9 | |
| Raw material | Modified Chilean | Package |
| Code | | Pouch: Tiromat |
| Dimensions | 22 mm 4.5 oz | |
| Species | Atlantic | Packaging around tray |
| Glazed | yes (mustard) | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove after 12 mins | |
| Start Temp | −15 C. | |
| Cook Time/Temp | 12 mins = 121 | 12 mins = 115 |
| | +2 mins = 129.7 | +2 mins = 123.2 |
| | +5 min = 132.3 | +5 min = 126.0 |
| | Piece 1 | Piece 2 |
| Weight in (g) (w/ bag 7 g) | 169.3 | 171.6 |
| Weight out (g) (fish) | | |
| Yield (%) (fish) | #VALUE! | #VALUE! |
| Weight out (g) (fish + juice + | 159.9 | 159.7 |
| bag) | | |
| Yield (%) (fish + juice) | 94% | 93% |
| Thickness (mm) w/poly and gla [symbol] | 25.38 | 27.1 |
| Width (mm) w/poly and glaze | 70.16 | 53.58 |
| Length (mm) w/poly and glaze | 122.58 | 134.67 |
| Observations | | Slight bitter to mustard |
| | | less acidic, acidic with sauce only |
| Exudate amount (visual) | none | |
| Texture | #1 good bite #2 soft mushy | |
| Fat between flakes | yes | |
| Pictures | yes | |
| Logger | no | |
| Next Steps | | |
| Test number | RW 674- | |
| Date | 16/8/2016 | |
| Hours logged | JB-1/2 | |
| Purpose of this test | repeat D101 | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/instructions | boil/add fish/cover/turn off/remove after 12 mins | |
| Start Temp | −15 C. | |
| Cook Time/Temp | 12 mins = 126 | 12 mins = 128 |
| | +2 mins = | +2 mins = |
| | Piece 1 (bigger) | Piece 2 |
| Weight in (g) (w/ bag) | 167.9 | 162.4 |
| Weight out (g) (fish) | 127.1 | 125.6 |
| Yield (%) (fish) | 75.7% | 77.3% |
| Weight out (g) (fish + juice + | 167.4 | 162.1 |
| bag) | | |
| Yield (%) (fish + juice) | 100% | 100% |
| Thickness (mm) | 25.9 | 26.2 |
| Width (mm) | 63.9 | 59.3 |
| Length (mm) | 123.9 | 128.9 |
| Observations | | |
| Exudate amount (visual) | a couple little blobs | |
| Texture | mushy/undercooked | |
| Fat between flakes | tiny bit | |
| Pictures | yes | |
| Logger | no | |
| Next Steps | | |
| Test number | RW 674- | |
| Date | 16/8/2016 | |
| Hours logged | JB-1/2 | |
| Purpose of this test | repeat D101 | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove after 12 mins | |
| Start Temp | −15 C. | |
| Cook Time/Temp | 12 mins = 129 | 12 mins = 145 |
| | +2 mins = 134 | +2 mins = 146 |
| | Piece 1 (bigger) | Piece 2 |
| Weight in (g) (w/ bag) | 162.6 | 174 |
| Weight out (g) (fish) | 130 | 140.6 |
| Yield (%) (fish) | 80.0% | 80.8% |
| Weight out (g) (fish + juice + | 156.9 | 176.4 |
| bag) | | |
| Yield (%) (fish + juice) | 96% | 101% |
| Thickness (mm) | 22.1 | 24.8 |
| Width (mm) | 71.5 | 66.1 |
| Length (mm) | 121.4 | 115.7 |
| Observations | | a little raw |
| Exudate amount (visual) | none | |
| Texture | typical | |
| Fat between flakes | yes | |
| Pictures | yes | |
| Logger | no | |
| Next Steps | | |
| Test number | RW 674-D103 | |
| Date | 16/8/2016 | |
| Hours logged | JB-1/2 | |
| Purpose of this test | repeat D101 | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove after 12 mins | |
| Start Temp | −15 C. | |
| Cook Time/Temp | 12 mins = 156 | 12 mins = 116 |
| | +2 mins = 149 | +2 mins = 127 |
| | Piece 1 | Piece 2 (bigger) |
| Weight in (g) (w/ bag) | 159.9 | 158.1 |
| Weight out (g) (fish) | 126 | 118.5 |
| Yield (%) (fish) | 78.8% | 75.0% |
| Weight out (g) (fish + juice + | 156.7 | 152.1 |
| bag) | | |
| Yield (%) (fish + juice) | 98% | 96% |
| Thickness (mm) | 24.2 | 22.8 |
| Width (mm) | 63.4 | 74 |
| Length (mm) | 113.5 | 120.4 |
| Observations | | |
| Exudate amount (visual) | almost none | |
| Texture | typical | |
| Fat between flakes | yes | |
| Pictures | yes | |
| Logger | no | |
| Next Steps | | |
| Test number | RW 674-D102 | |
| Date | 15/8/2016 | |
| Hours logged | JB-1/2 | |
| Purpose of this test | repeat D101 | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove after 12 mins | |
| Start Temp | −15 C. | |
| Cook Time/Temp | 12 mins = 134 | 12 mins = 117 |
| | +2 mins = 138 | +2 mins = 124 |
| | Piece 1 | Piece 2 (skinnier) |
| Weight in (g) (w/ bag) | 171.3 | 154.6 |
| Weight out (g) (fish) | 139 | 121.4 |
| Yield (%) (fish) | 81.1% | 78.5% |
| Weight out (g) (fish + juice + | 170.5 | 143.5 |
| bag) | | |
| Yield (%) (fish + juice) | 100% | 93% |
| Thickness (mm) | 24.7 | 26.4 |
| Width (mm) | 66.9 | 52.2 |
| Length (mm) | 124.1 | 134.4 |
| Observations | some liquid out of bags when weighed | |
| | shredded look (pc2) and didn't flake well | |
| | undercooked | |
| Exudate amount (visual) | very tiny along fat line | |
| Texture | typical | kinda watery/mushy |
| Fat between flakes | yes | |
| Pictures | yes | |
| Logger | no | |
| Next Steps | | |
| Test number | RW 674- | |
| Date | 15/8/2016 | |
| Hours logged | JB-1/2 | |
| Purpose of this test | check cook prep instructions w/ produced pieces from Aug 9 | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove after 12 mins | |
| Start Temp | −15 C. | |
| Cook Time/Temp | 12 mins = 116 | 12 mins = 125 |
| | +2 mins = 128 | +2 mins = 132 |
| | Piece 1 (bigger) | Piece 2 |
| Weight in (g) (w/ bag) | 167.9 | 160.7 |
| Weight out (g) (fish) | 130.6 | 127.2 |
| Yield (%) (fish) | 77.8% | 79.2% |
| Weight out (g) (fish + juice + | 162.9 | 159.8 |
| bag) | | |
| Yield (%) (fish + juice) | 97% | 99% |
| Thickness (mm) | 26.3 | 26.5 |
| Width (mm) | 65.6 | 54.1 |
| Length (mm) | 130.8 | 131.9 |
| Observations | | |
| Exudate amount (visual) | none | |
| Texture | typical, a bit watery | |
| Fat between flakes | yes | |
| Pictures | yes | |
| Logger | no | |
| Next Steps | | |
| Test number | RW 674-D100 | |
| Date | 4/8/2016 | |
| Hours logged | JB-1/2 | |
| Purpose of this test | repeat D96 | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 F. at 11:15 | 138 F. at 11:34 |
| | Piece 1 (skinny) | Piece 2 |
| Weight in (g) | 125.9 | 136.3 |
| Weight out (g) (fish) | 115.6 | 125.3 |
| Yield (%) (fish) | 91.8% | 91.9% |
| Weight out (g) (fish + juice) | 124.2 | 133.5 |
| Yield (%) (fish + juice) | 98.6% | 97.9% |
| Thickness (mm) | 21.2 | 23.2 |
| Width (mm) | 56.8 | 76.6 |
| Length (mm) | 137 | 94.4 |
| Observations | | |
| Exudate amount (visual) | none | |
| Texture | typical | |
| Fat between flakes | yes | |
| Pictures | yes | |
| Logger | yes | |
| Next Steps | | |
| Test number | RW 674-D99 | |
| Date | 4/8/2016 | |
| Hours logged | JB-1/2 | |
| Purpose of this test | repeat D96 | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 F. at 11:19 | 138 F. at 10:25 |
| | Piece 1 | Piece 2 (angle) |
| Weight in (g) | 129.4 | 126 |
| Weight out (g) (fish) | 117.3 | 112.7 |
| Yield (%) (fish) | 90.6% | 89.4% |
| Weight out (g) (fish + juice) | 126.4 | 125.1 |
| Yield (%) (fish + juice) | 97.7% | 99.3% |
| Thickness (mm) | 22.6 | 22.5 |
| Width (mm) | 78.7 | 77.9 |
| Length (mm) | 81.6 | 87.8 |
| Observations | not cooked section pc 1 | not well vacuum packed pc 2 |
| Exudate amount (visual) | tiny bit | |
| Texture | fairly typical, a bit chewy/mushy | |
| Fat between flakes | yes | |
| Pictures | yes | |
| Logger | yes | |
| Next Steps | | |
| Test number | RW 674-D98 | |
| Date | 4/8/2016 | |
| Hours logged | JB-1/2 | |
| Purpose of this test | repeat D96 | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 F. at 12:21 | 138 F. at 16:17 |
| | Piece 1 | Piece 2 (square) |
| Weight in (g) | 121.8 | 140.9 |
| Weight out (g) (fish) | 109.1 | 126.2 |
| Yield (%) (fish) | 89.6% | 89.6% |
| Weight out (g) (fish + juice) | 119.4 | 137.7 |
| Yield (%) (fish + juice) | 98.0% | 97.7% |
| Thickness (mm) | 21.9 | 22.7 |
| Width (mm) | 62.9 | 74.7 |
| Length (mm) | 110.6 | 90.2 |
| Observations | neither had good vacuum - both had corners that were floating | |
| Exudate amount (visual) | none | |
| Texture | typical | |
| Fat between flakes | yes | |
| Pictures | yes | |
| Logger | yes | |
| Next Steps | | |
| Test number | RW 674-D97 | |
| Date | 4/8/2016 | |
| Hours logged | JB-1/2 | |
| Purpose of this test | repeat D96 | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 F. at 15:55 | 138 F. at 10:46 |
| | Piece 1 (angled out) | Piece 2 |
| Weight in (g) | 148.4 | 123 |
| Weight out (g) (fish) | 134.2 | 110.9 |
| Yield (%) (fish) | 90.4% | 90.2% |
| Weight out (g) (fish + juice) | 148.4 | 120.5 |
| Yield (%) (fish + juice) | 100.0% | 98.0% |
| Thickness (mm) | 22.9 | 21.3 |
| Width (mm) | 64.7 | 65.1 |
| Length (mm) | 126.9 | 119.6 |
| Observations | | |
| Exudate amount (visual) | none | |
| Texture | typical | |
| Fat between flakes | yes | |
| Pictures | yes | |
| Logger | yes | |
| Next Steps | | |
| Test number | RW 674-D96 | |
| Date | 4/8/2016 | |
| Hours logged | JB-1 | |
| Purpose of this test | lime chili marinade (repeat D32 - 15% powder, 10% pickup) | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 F. at 10:58 | 138 F. at 11:08 |
| | Piece 1 (skinny) | Piece 2 |
| Weight in (g) | 131 | 132.1 |
| Weight out (g) (fish) | 117.5 | 118.2 |
| Yield (%) (fish) | 89.7% | 89.5% |
| Weight out (g) (fish + juice) | 127.8 | 130.4 |
| Yield (%) (fish + juice) | 97.6% | 98.7% |
| Thickness (mm) | 21.2 | 21.9 |
| Width (mm) | 53.7 | 81 |
| Length (mm) | 137.5 | 83.4 |
| Observations | not removed right at 138 | |
| | some oil separation in glaze | |
| Exudate amount (visual) | none | |
| Texture | typical | |
| Fat between flakes | yes | |
| Pictures | yes | |
| Logger | yes | |
| Next Steps | | |
| Test number | RW 674-D95 | |
| Date | 29/7/16 | |
| Hours logged | JB-1 | |
| Purpose of this test | repeat D91 | |
| Raw material | | Package |
| Code | | Pouch: in-house poly |
| Dimensions | | |
| Species | | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 F. at 10:20 | 138 F. at 11:42 |
| | Piece 1 | Piece 2 |
| Weight in (g) | 126.5 | 128.1 |
| Weight out (g) (fish) | 96 | 100.9 |
| Yield (%) (fish) | 75.9% | 78.8% |
| Weight out (g) (fish + juice) | 122.8 | 123.6 |
| Yield (%) (fish + juice) | 97.1% | 96.5% |
| Thickness (mm) | 20.7 | 24.3 |
| Width (mm) | 82.5 | 79.7 |
| Length (mm) | 101.6 | 95.5 |
| Observations | some pieces of pacific salmon have gaps in middle that | |
| | probe goes into = “faster” cooking” | |
| | both had corners floating | |
| Exudate amount (visual) | some clumps | |
| Texture | typical | |
| Fat between flakes | yes | |
| Pictures | yes | |
| Logger | yes | |
| Next Steps | | |
| Test number | RW 674-D94 | |
| Date | 29/7/16 | |
| Hours logged | JB-1 | |
| Purpose of this test | repeat D91 | |
| Raw material | | Package |
| Code | | Pouch: in-house poly |
| Dimensions | | |
| Species | | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 F. at 10:45 | 138 F. at 10:25 |
| | Piece 1 | Piece 2 |
| Weight in (g) | 129.9 | 127.9 |
| Weight out (g) (fish) | 103.6 | 100.2 |
| Yield (%) (fish) | 79.8% | 78.3% |
| Weight out (g) (fish + juice) | 125.8 | 124.4 |
| Yield (%) (fish + juice) | 96.8% | 97.3% |
| Thickness (mm) | 22.8 | 21.5 |
| Width (mm) | 80.1 | 74.6 |
| Length (mm) | 94.9 | 125.8 |
| Observations | spot not cooked (where touched other | |
| | bag?) | |
| Exudate amount (visual) | hardly any | |
| Texture | typical | |
| Fat between flakes | yes | |
| Pictures | yes | |
| Logger | yes | |
| Next Steps | | |
| Test number | RW 674-D93 | |
| Date | 29/7/16 | |
| Hours logged | JB-1 | |
| Purpose of this test | repeat D91 | |
| Raw material | | Package |
| Code | | Pouch: in-house poly |
| Dimensions | | |
| Species | | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 F. at 17:25 | 138 F. at 16:18 |
| | Piece 1 | Piece 2 |
| Weight in (g) | 137.9 | 133.6 |
| Weight out (g) (fish) | 106.3 | 104.7 |
| Yield (%) (fish) | 77.1% | 78.4% |
| Weight out (g) (fish + juice) | 133.5 | 128 |
| Yield (%) (fish + juice) | 96.8% | 95.8% |
| Thickness (mm) | 22.7 | 23.9 |
| Width (mm) | 75.8 | 83.5 |
| Length (mm) | 121.9 | 110.5 |
| Observations | | |
| Exudate amount (visual) | a little in grooves | hardly any |
| Texture | typical | |
| Fat between flakes | yes | a little |
| Pictures | yes | |
| Logger | yes | |
| Next Steps | | |
| Test number | RW 674-D92 | |
| Date | 29/7/16 | |
| Hours logged | JB-1 | |
| Purpose of this test | repeat D91 | |
| Raw material | | Package |
| Code | | Pouch: in-house poly |
| Dimensions | | |
| Species | | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 F. at 10:55 | 138 F. at 8:24 |
| | Piece 1 | Piece 2 |
| Weight in (g) | 140 | 147.9 |
| Weight out (g) (fish) | 109.7 | 115.2 |
| Yield (%) (fish) | 78.4% | 77.9% |
| Weight out (g) (fish + juice) | 136 | 143.5 |
| Yield (%) (fish + juice) | 97.1% | 97.0% |
| Thickness (mm) | 24.7 | 21.5 |
| Width (mm) | 86.3 | 78.4 |
| Length (mm) | 122.8 | 110.9 |
| Observations | vac pac issues - didn't start at −15 C. | probable probe error |
| | corner floating | not good vacuum |
| | one section didn't cook | corner floating |
| Exudate amount (visual) | a little | stringy clumps |
| Texture | typical, a little chewy | typical, a little mushy |
| Fat between flakes | yes | |
| Pictures | yes | |
| Logger | yes | |
| Next Steps | | |
| Test number | RW 674-D91 | |
| Date | 18/7/2016 | |
| Hours logged | JB-1 | |
| Purpose of this test | roasted garlic and herb: test if performs similar to MM | |
| Raw material | | Package |
| Code | | Pouch: in-house poly |
| Dimensions | | |
| Species | | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 F. at 12:25 | 138 F. at 11:16 |
| | Piece 1 (more square/sauce) | Piece 2 |
| Weight in (g) | 140.5 | 142.8 |
| Weight out (g) (fish) | 108.1 | 113.9 |
| Yield (%) (fish) | 76.9% | 79.8% |
| Weight out (g) (fish + juice) | 135 | 138.5 |
| Yield (%) (fish + juice) | 96.1% | 97.0% |
| Thickness (mm) | 23.6 | 24.6 |
| Width (mm) | 85.1 | 80.6 |
| Length (mm) | 99.6 | 104.9 |
| Observations | floating a bit | lost vacuum, floats |
| | flakes apart easily | probe not in center |
| | | not cooked completely |
| Exudate amount (visual) | some, in blobs | |
| Texture | typical | |
| Fat between flakes | yes | |
| Pictures | yes | |
| Logger | yes | |
| Next Steps | repeat | |
| Test number | RW 674-D90 | |
| Date | 11/7/2016 | |
| Hours logged | JB-1/2 | |
| Purpose of this test | repeat D89 | |
| Raw material | Modified Chilean | Package |
| Code | | Pouch: in-house poly |
| Dimensions | 22 mm 4.5 oz | |
| Species | Atlantic | Packaging around tray |
| Glazed | no | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 F. at 12:42 | 138 F. at 11:52 |
| | Piece 1 | Piece 2 (longer) |
| Weight in (g) | 123.4 | 159.4 |
| Weight out (g) (fish) | 114.1 | 146.6 |
| Yield (%) (fish) | 92.5% | 92.0% |
| Weight out (g) (fish + juice) | 122.5 | 158.2 |
| Yield (%) (fish + juice) | 99.3% | 99.2% |
| Thickness (mm) | 23.5 | 22.2 |
| Width (mm) | 47.8 | 54.3 |
| Length (mm) | 153.9 | 193.4 |
| Observations | | |
| Exudate amount (visual) | thin layer over fish, more in folds of poly | |
| Texture | watery, mushy | |
| Fat between flakes | not much | |
| Pictures | yes | |
| Logger | yes | |
| Next Steps | | |
| Test number | RW 674-D89 | |
| Date | 11/7/2016 | |
| Hours logged | JB-1 | |
| Purpose of this test | test meat tenderizer pushed all the way through fresh raw salmon | |
| Raw material | Modified Chilean | Package |
| Code | | Pouch: in-house poly |
| Dimensions | 22 mm 4.5 oz | |
| Species | Atlantic | Packaging around tray |
| Glazed | no | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 F. at 9:10 | 138 F. at 11:34 |
| | Piece 1 (skinnier) | Piece 2 |
| Weight in (g) | 126.8 | 132.7 |
| Weight out (g) (fish) | 119.1 | 121.7 |
| Yield (%) (fish) | 93.9% | 91.7% |
| Weight out (g) (fish + juice) | 130.8 | 131.7 |
| Yield (%) (fish + juice) | 103.2% | 99.2% |
| Thickness (mm) | 21.3 | 22.5 |
| Width (mm) | 58 | 65.7 |
| Length (mm) | 159.4 | 136.7 |
| Observations | piece 1 - corner of bag floating, air in | |
| | bag - one area didn't cook | |
| Exudate amount (visual) | thin coating surrounding fish and some blotches | |
| Texture | watery/mushy/chewy/wooly | |
| Fat between flakes | not a lot, stringy | |
| Pictures | yes | |
| Logger | yes | |
| Next Steps | repeat | |
| Test number | RW 674-D88 | |
| Date | 8/7/2016 | |
| Hours logged | JB-1/2 | |
| Purpose of this test | test sauce placed in vacuum bag then fish then sealed | |
| Raw material | Modified Chilean | Package |
| Code | | Pouch: in-house poly |
| Dimensions | 22 mm 4.5 oz | |
| Species | Atlantic | Packaging around tray |
| Glazed | yes. MM6 | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 12 minutes | |
| Start Temp | −15 C. | |
| Cook Time/Temp | 145 F. at | 145 F. at |
| | Piece 1 | Piece 2 |
| Weight in (g) | | |
| Weight out (g) (fish) | | |
| Yield (%) (fish) | | |
| Weight out (g) (fish + juice) | | |
| Yield (%) (fish + juice) | | |
| Thickness (mm) | | |
| Width (mm) | | |
| Length (mm) | | |
| Observations | yellow liquid visible on side of fish not covered by sauce | |
| | (inside bag) MM sauce didn't go over to the other side during | |
| | whole cook time when shaken, sauce in bag becomes similar to | |
| | normal unshaken bag required more squeezing to get sauce out | |
| | of bag and yellow liquid pooled around fish | |
| Exudate amount (visual) | none | |
| Texture | fairly typical | |
| Fat between flakes | yes | |
| Pictures | lots | |
| Logger | none | |
| Next Steps | | |
| Test number | RW 674-D87 | |
| Date | 5/7/2016 | |
| Hours logged | JB-1/2 | |
| Purpose of this test | Fleur de Dijon (compare to D86) | |
| Raw material | Modified Chilean | Package |
| Code | | Pouch: in-house poly |
| Dimensions | 22 mm 4.5 oz | |
| Species | Atlantic | Packaging around tray |
| Glazed | yes (MM6) | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil' | |
| Results: | | |
| Cook Method/Instructions | boil/add fish/cover/turn off/remove at 138 | |
| Start Temp | −15 C. | |
| Cook Time/Temp | datalogger | 138 at 24:13 |
| | Piece 1 (skinny) | Piece 2 |
| Weight in (g) | 147.8 | 149.4 |
| Weight out (g) (fish) | 124.6 | 133 |
| Yield (%) (fish) | 84.3% | 89.0% |
| Weight out (g) (fish + juice) | 145 | 146.8 |
| Yield (%) (fish + juice) | 98.1% | 98.3% |
| Thickness (mm) | 28.2 | 25.7 |
| Width (mm) | 50.5 | 62.5 |
| Length (mm) | 144.4 | 118.55 |
| Observations | Note that raw mat is from fresh fillet that was tested | |
| | in lab then cut up into portions | |
| | Piece 1 removed from pot at 18:30ish when >138 F. | |
| | Probe came out of piece 2 when removed from pot | |
| Exudate amount (visual) | blotches | |
| Texture | typical | |
| Fat between flakes | yes | |
| Pictures | yes | |
| Logger | yes | |
| Next Steps | | |
| Test number | RW 674-D86 | |
| Date | 5/7/2016 | |
| Hours logged | JB-1/2 | |
| Purpose of this test | Maille (compare to D87) | |
| Raw material | Modified Chilean | Package |
| Code | | Pouch: in-house poly |
| Dimensions | 22 mm 4.5 oz | |
| Species | Atlantic | Packaging around tray |
| Glazed | yes (MM6) | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 at 18:32 | 138 at 15:32 |
| | Piece 1 (skinnier) | Piece 2 |
| Weight in (g) | 144.1 | 146.4 |
| Weight out (g) (fish) | 124.1 | 128 |
| Yield (%) (fish) | 86.1% | 87.4% |
| Weight out (g) (fish + juice) | 141.2 | 149.4 |
| Yield (%) (fish + juice) | 98.0% | 102.0% |
| Thickness (mm) | 25.7 | 26.3 |
| Width (mm) | 47.9 | 51.2 |
| Length (mm) | 147.1 | 137.6 |
| Observations | Note that raw mat is from fresh fillet that was tested in | |
| | lab then cut up into portions | |
| | Air in both bags when done cooking | |
| Exudate amount (visual) | some blotches | blotches in bag |
| Texture | typical | |
| Fat between flakes | yes | |
| Pictures | yes | |
| Logger | date is wrong. | |
| Next Steps | | |
| Test number | RW 674-D85 | |
| Date | 28/6/2016 | |
| Hours logged | JB-1/2 | |
| Purpose of this test | repeat D69 | |
| Raw material | Modified Chilean | Package |
| Code | | Pouch: in-house poly |
| Dimensions | 22 mm 4.5 oz | |
| Species | Atlantic | Packaging around tray |
| Glazed | Mesquite Rub | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat top | |
| Results: | | |
| Cook Method/Instructions | boil/add fish/cover/turn off/remove at 138 | |
| Start Temp | −15 C. | |
| Cook Time/Temp | 138 at 12:38 | 138 at 12:57 |
| | Piece 1 (#5) | Piece 2 (#6) long |
| Weight in (g) | 127.1 | 137.5 |
| Weight out (g) (fish) | 122.6 | 135.1 |
| Yield (%) (fish) | 96.5% | 98.3% |
| Weight out (g) (fish + juice) | 124 | |
| Yield (%) (fish + juice) | 97.6% | |
| Thickness (mm) | 22.3 | 22.7 |
| Width (mm) | 64.2 | 55 |
| Length (mm) | 103.1 | 149.1 |
| Observations | | |
| Exudate amount (visual) | none | |
| Texture | typical | |
| Fat between flakes | yes | |
| Pictures | yes | |
| Logger | yes | |
| Next Steps | | |
| Test number | RW 674-D84 | |
| Date | 28/6/2016 | |
| Hours logged | JB-1/2 | |
| Purpose of this test | 10 cups water for 1 piece fish | |
| Raw material | Modified Chilean | Package |
| Code | | Pouch: in-house poly |
| Dimensions | 22 mm 4.5 oz | |
| Species | Atlantic | Packaging around tray |
| Glazed | yes MM7 | Other package info |
| Skin on/off | off | |
| Cooking method | | |
| Pot description | non-stick pot | |
| Cover type | glass | |
| Heat setting | boil then turn off | |
| Water quantity | 10 cups | |
| Stove type | coil | |
| Results: | | |
| Cook Method/Instructions | boil/add fish/cover/turn off/remove at 138 | |
| Start Temp | −15 C. | |
| Cook Time/Temp | 138 at 12:09 | 145 F. at |
| | Piece 1 (MM7 #4) | Piece 2 |
| Weight in (g) | 152.2 | |
| Weight out (g) (fish) | 136.5 | |
| Yield (%) (fish) | 89.7% | |
| Weight out (g) (fish + juice) | 152 | |
| Yield (%) (fish + juice) | 99.9% | |
| Thickness (mm) | 24.9 | |
| Width (mm) | 72.2 | |
| Length (mm) | 104.6 | |
| Observations | | |
| Exudate amount (visual) | a tiny bit in bag | |
| Texture | chewy | |
| Fat between flakes | yes | |
| Pictures | yes | |
| Logger | yes | |
| Next Steps | | |
| Test number | RW 674-D83 | |
| Date | 28/6/2016 | |
| Hours logged | JB-1/2 | |
| Purpose of this test | 8 cups water, 1 piece fish | |
| Raw material | Modified Chilean | Package |
| Code | | Pouch: in-house poly |
| Dimensions | 22 mm 4.5 oz | |
| Species | Atlantic | Packaging around tray |
| Glazed | yes. MM7 | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/instructions | boil/add fish/cover/turn off/remove at 138 | |
| Start Temp | −15 C. | |
| Cook Time/Temp | 138 at 12:55 | 145 F. at |
| | Piece 1 (MM7 #3) | Piece 2 |
| Weight in (g) | 138.1 | |
| Weight out (g) (fish) | 124.5 | |
| Yield (%) (fish) | 90.2% | |
| Weight out (g) (fish + juice) | 138 | |
| Yield (%) (fish + juice) | 99.9% | |
| Thickness (mm) | 23.9 | |
| Width (mm) | 67.1 | |
| Length (mm) | 101.9 | |
| Observations | | |
| Exudate amount (visual) | none | |
| Texture | typical | |
| Fat between flakes | yes | |
| Pictures | yes | |
| Logger | yes | |
| Next Steps | | |
| Test number | RW 674-D82 | |
| Date | 28/6/2016 | |
| Hours logged | JB-1/2 | |
| Purpose of this test | 6 cups water and 1 piece fish | |
| Raw material | Modified Chilean | Package |
| Code | | Pouch: in-house poly |
| Dimensions | 22 mm 4.5 oz | |
| Species | Atlantic | Packaging around tray |
| Glazed | yes-MM7 | Other package info |
| Skin on/off | off | |
| Cooking method | | |
| Pot description | non-stick pot | |
| Cover type | glass | |
| Heat setting | boil then turn off | |
| Water quantity | 6 cups | |
| Stove type | coil | |
| Results: | | |
| Cook Method/Instructions | boil/add fish/cover/turn off/remove at 138 | |
| Start Temp | −15 C. | |
| Cook Time/Temp | 138 at 15:20 | 145 F. at |
| | Piece 1 (MM7 #2) | Piece 2 |
| Weight in (g) | 147.1 | |
| Weight out (g) (fish) | 135 | |
| Yield (%) (fish) | 91.8% | |
| Weight out (g) (fish + juice) | 146.8 | |
| Yield (%) (fish + juice) | 99.8% | |
| Thickness (mm) | 23 | |
| Width (mm) | 75.3 | |
| Length (mm) | 98.6 | |
| Observations | air in bag after cooked | |
| | (i.e. not perfect vacuum seal) | |
| Exudate amount (visual) | can see some in package | |
| Texture | typical, a little chewy (freezer burnt) | |
| Fat between flakes | yes | |
| Pictures | yes | |
| Logger | yes | |
| Next Steps | repeat with more water | |
| Test number | RW 674-D81 | |
| Date | 24/6/2016 | |
| Hours logged | JB-1/2 | |
| Purpose of this test | repeat D78 | |
| Raw material | Modified Chilean | Package |
| Code | | Pouch: in-house poly |
| Dimensions | 20 mm 4.5 oz | |
| Species | Atlantic | Packaging around tray |
| Glazed | yes (MM6) | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 12 min | |
| Start Temp | −15 C. | |
| Cook Time/Temp | | |
| | Piece 1 (#5) | Piece 2 (var thickness) |
| Weight in (g) | 132.9 | 148.9 |
| Weight out (g) (fish) | 120 | |
| Yield (%) (fish) | 90.3% | |
| Weight out (g) (fish + juice) | 134.7 | |
| Yield (%) (fish + juice) | 101.4% | |
| Thickness (mm) | 21.3 | |
| Width (mm) | 51.7 | |
| Length (mm) | 137.8 | |
| Observations | out at 12, rest in bag 2 minutes, | |
| | temp at 15:30 => 145 | |
| Exudate amount (visual) | none | |
| Texture | typical | |
| Fat between flakes | yes | |
| Pictures | yes | |
| Logger | probe too close to surface of fish | |
| Next Steps | | |
| Test number | RW 674-D80 | |
| Date | 24/6/2016 | |
| Hours logged | JB-1/2 | |
| Purpose of this test | repeat D78 | |
| Raw material | Modified Chilean | Package |
| Code | | Pouch: in-house poly |
| Dimensions | 20 mm 4.5 oz | |
| Species | Atlantic | Packaging around tray |
| Glazed | yes (MM6) | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 at 11:52 | 138 at 12:49 |
| | Piece 1 (#6) thick fat line | Piece 2 (#7) more sauce |
| Weight in (g) | 133.9 | 145.4 |
| Weight out (g) (fish) | 119 | 129 |
| Yield (%) (fish) | 88.9% | 88.7% |
| Weight out (g) (fish + juice) | 130.7 | 142.3 |
| Yield (%) (fish + juice) | 97.6% | 97.9% |
| Thickness (mm) | 23.8 | 24.5 |
| Width (mm) | 62.2 | 64.6 |
| Length (mm) | 115.9 | 127.8 |
| Observations | not really 20 mm | |
| Exudate amount (visual) | none | |
| Texture | typical, on the soft side | |
| Fat between flakes | yes | |
| Pictures | yes | |
| Logger | yes | |
| Next Steps | | |
| Test number | RW 674-D79 | |
| Date | 24/6/2016 | |
| Hours logged | JB-1/2 | |
| Purpose of this test | repeat D78 | |
| Raw material | Modified Chilean | Package |
| Code | | Pouch: in-house poly |
| Dimensions | 20 mm 4.5 oz | |
| Species | Atlantic | Packaging around tray |
| Glazed | yes (MM6) | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 at 14:00 | 138 at 12:40 |
| | Piece 1 (#3) weird shape | Piece 2 (#4) long and skinny |
| Weight in (g) | 143.1 | 142.2 |
| Weight out (g) (fish) | 124.1 | 124.3 |
| Yield (%) (fish) | 86.7% | 87.4% |
| Weight out (g) (fish + juice) | 140.3 | 142.9 |
| Yield (%) (fish + juice) | 98.0% | 100.5% |
| Thickness (mm) | 22.5 | 22.6 |
| Width (mm) | 87.9 | 52.1 |
| Length (mm) | 103.3 | 155 |
| Observations | didn't take out at 138 | |
| 1 Exudate amount (visual) | none | |
| Texture | typical | |
| Fat between flakes | yes | |
| Pictures | yes | |
| Logger | yes | |
| Next Steps | | |
| Test number | RW 674-D78 | |
| Date | 24/6/2016 | |
| Hours logged | JB-1 | |
| Purpose of this test | 20 mm w/sauce | |
| Raw material | Modified Chilean | Package |
| Code | | Pouch: in-house poly |
| Dimensions | 20 mm 4.5 oz | |
| Species | Atlantic | Packaging around tray |
| Glazed | yes (MM6) | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 at 13:28 | 138 at 13:57 |
| | Piece 1 (#1) T1 (more sauce) | Piece 2 (#2) T3 (bigger fat line) |
| Weight in (g) | 129.7 | 139.2 |
| Weight out (g) (fish) | 113 | 123 |
| Yield (%) (fish) | 87.1% | 88.4% |
| Weight out (g) (fish + juice) | 126 | 135 |
| Yield (%) (fish + juice) | 97.1% | 97.0% |
| Thickness (mm) | 21.5 | 21.5 |
| Width (mm) | 61.66 | 66.15 |
| Length (mm) | 123.5 | 125.9 |
| Observations | | not complete vacuum |
| Exudate amount (visual) | none | |
| Texture | fairly typical, a little chewy | |
| Fat between flakes | yes | |
| Pictures | yes | |
| Logger | yes | |
| Next Steps | | |
| Test number | RW 674-D77 | |
| Date | 21/6/2016 | |
| Hours logged | JB-1/2 | |
| Purpose of this test | 6 cups, 2 pieces, MM4 | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 at 12:24 | 138 at 14:37 |
| | Piece 1 (shorter) (#3) | Piece 2 (#4) |
| Weight in (g) | 132.7 | 156.6 |
| Weight out (g) (fish) | 116.8 | 135.7 |
| Yield (%) (fish) | 88.0% | 86.7% |
| Weight out (g) (fish + juice) | 131.5 | 154.6 |
| Yield (%) (fish + juice) | 99.1% | 98.7% |
| Thickness (mm) | 23.6 | 24.3 |
| Width (mm) | 62.7 | 60 |
| Length (mm) | 121.5 | 138.4 |
| Observations | | |
| Exudate amount (visual) | none | a little glob on one side |
| Texture | typical | |
| Fat between flakes | yes | |
| Pictures | yes | |
| Logger | yes | |
| Next Steps | | |
| Test number | RW 674-D76 | |
| Date | 21/6/2016 | |
| Hours logged | JB-1/2 | |
| Purpose of this test | 10 cups, 2 pieces, MM5 | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 at 11:02 | 138 at 11:39 |
| | Piece 1 (‘square’) (#2) | Piece 2 (#4) |
| Weight in (g) | 153.8 | 138.3 |
| Weight out (g) (fish) | 130.1 | 122 |
| Yield (%) (fish) | 84.6% | 88.2% |
| Weight out (g) (fish) + juice) | 150.6 | 135.5 |
| Yield (%) (fish + juice) | 97.9% | 98.0% |
| Thickness (mm) | 23.4 | 23.7 |
| Width (mm) | 76.2 | 60.1 |
| Length (mm) | 101.1 | 129.6 |
| Observations | water splashes over edge of pot when | |
| | boiling | |
| Exudate amount (visual) | none | |
| Texture | a little watery | |
| Fat between flakes | yes | |
| Pictures | yes | |
| Logger | yes | |
| Next Steps | | |
| Test number | RW 674-D75 | |
| Date | 21/6/2016 | |
| Hours logged | JB-1/2 | |
| Purpose of this test | repeat D74 | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 at 12:07 | |
| | Piece 1 | |
| Weight in (g) | 143.3 | |
| Weight out (g) (fish) | 122.5 | |
| Yield (%) (fish) | 85.5% | |
| Weight out (g) (fish + juice) | 141 | |
| Yield (%) (fish + juice) | 98.4% | |
| Thickness (mm) | 22.8 | |
| Width (mm) | 63.7 | |
| Length (mm) | 122.2 | |
| Observations | leak in package? | |
| Exudate amount (visual) | none | |
| Texture | chewy and dry but freezer burnt | |
| Fat between flakes | yes | |
| Pictures | yes | |
| Logger | yes | |
| Next Steps | | |
| Test number | RW 674-D74 | |
| Date | 21/6/2016 | |
| Hours logged | JB-1 | |
| Purpose of this test | 4 cups water - 1 piece | |
| | MM3 | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 at 11:29 | |
| | Piece 1 | |
| Weight in (g) | 150.1 | |
| Weight out (g) (fish) | 135.4 | |
| Yield (%) (fish) | 90.2% | |
| Weight out (g) (fish + juice) | 148.1 | |
| Yield (%) (fish + juice) | 98.7% | |
| Thickness (mm) | 23.7 | |
| Width (mm) | 66.9 | |
| Length (mm) | 133 | |
| Observations | | |
| Exudate amount (visual) | none | |
| Texture | a bit watery | |
| Fat between flakes | yes | |
| Pictures | yes | |
| Logger | logger is 10 s behind. Water probe not in | |
| Next Steps | repeat | |
| Test number | RW 674-D73 | |
| Date | 20/6/2016 | |
| Hours logged | JB-1 | |
| Purpose of this test | compare MM7 with MM6 | |
| Raw material | Modified Chilean | Package |
| Code | | Pouch: in-house poly/tiromat |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 12 minutes/rest 2 minutes | |
| Start Temp | −15 C. | |
| Cook Time/Temp | 145 F. at | 145 F. at |
| | Piece 1 - MM6 in tiromat (longer) | Piece 2 (MM7 in in-house poly) |
| Weight in (g) | | |
| Weight out (g) (fish) | | |
| Yield (%) (fish) | | |
| Weight out (g) (fish + juice) | | |
| Yield (%) (fish + juice) | | |
| Thickness (mm) | | |
| Width (mm) | | |
| Length (mm) | | |
| Observations | cooked enough with 12 + 2 | |
| Exudate amount (visual) | none | |
| Texture | good | |
| Fat between flakes | yes | |
| Pictures | yes | |
| Logger | none | |
| Next Steps | continue with no black pepper or coriander | |
| Test number | RW 674-D72 | |
| Date | 16/6/2016 | |
| Hours logged | JB-1 | |
| Purpose of this test | MM5 | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 at 11:50; 145 F. at | 138 at 12:29 |
| | Piece 1 (#1) | Piece 2 (#3) (longer) |
| Weight in (g) | 145.6 | 141.9 |
| Weight out (g) (fish) | 129.8 | 127 |
| Yield (%) (fish) | 89.1% | 89.5% |
| Weight out (g) (fish + juice) | 140.1 | 138.8 |
| Yield (%) (fish + juice) | 96.2% | 97.8% |
| Thickness (mm) | 23.6 | 23.6 |
| Width (mm) | 77.25 | 63.5 |
| Length (mm) | 96.6 | 113.8 |
| Observations | a little bit of sauce left in bag | |
| | sauce doesn't stay on fish surface | |
| | sauce not snotty, a little clumpy | |
| Exudate amount (visual) | none | |
| Texture | fairly typical | |
| Fat between flakes | yes | |
| Pictures | yes | |
| Logger | probe 1 | probe 3 |
| Next Steps | | |
| Test number | RW 674-D71 | |
| Date | 14/6/2016 | |
| Hours logged | JB-1 | |
| Purpose of this test | MM with added starch (22 mm, unscored, RW 679-4, dipped 10/6/2016) | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 at 15:59 | 138 at 13:24 |
| | Piece 1 | Piece 2 (bigger) |
| Weight in (g) | 139.6 | 158.8 |
| Weight out (g) (fish) | 116.3 | 133 |
| Yield (%) (fish) | 83.3% | 83.8% |
| Weight out (g) (fish + juice) | 142.1 | 154.7 |
| Yield (%) (fish + juice) | 101.8% | 97.4% |
| Thickness (mm) | 23.6 | 22.9 |
| Width (mm) | 57.6 | 65.7 |
| Length (mm) | 134.9 | 143.6 |
| Observations | no squeezing of bag required | probe 2 moved once removed |
| | sauce looks very liquidy in bag | from pot at 138 |
| Exudate amount (visual) | none | |
| Texture | typical, a little watery | |
| Fat between flakes | yes | |
| Pictures | yes | |
| Logger | yes | |
| Next Steps | add some xanthum gum back in | |
| Test number | RW 674-D70 | |
| Date | 14/6/2016 | |
| Hours logged | JB-1 | |
| Purpose of this test | repeat D69 | |
| Raw material | Modified Chilean | Package |
| Code | | Pouch: in-house poly |
| Dimensions | 22 mm 4.5 oz | |
| Species | Atlantic | Packaging around tray |
| Glazed | yes (dry rub) | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 at 12:40 145 at 13:30 | 138 at 12:45 145 at 14:22 |
| | Piece 1 (tail) (#3) | Piece 2 (skinny) (#4) |
| Weight in (g) | 136.9 | 127.1 |
| Weight out (g) (fish) | 133.8 | 126 |
| Yield (%) (fish) | 97.7% | 99.1% |
| Weight out (g) (fish + juice) | | |
| Yield (%) (fish + juice) | | |
| Thickness (mm) | 22.6 | 22.3 |
| Width (mm) | 76.1 | 50.98 |
| Length (mm) | 111.7 | 133.4 |
| Observations | sauce gets thicker as temp decreases | |
| | piece 2 fell apart very easily | |
| Exudate amount (visual) | none | |
| Texture | typical | |
| Fat between flakes | yes | |
| Pictures | yes | |
| Logger | yes | |
| Next Steps | | |
| Test number | RW 674-D69 | |
| Date | 14/6/2016 | |
| Hours logged | JB-1 | |
| Purpose of this test | Mesquite Rub (Griffiths HLF3591) | |
| | 22 mm unscored, coated 13/6/2016 | |
| Raw material | Modified Chilean | Package |
| Code | | Pouch: in-house poly |
| Dimensions | 22 mm 4.5 oz | |
| Species | Atlantic | Packaging around tray |
| Glazed | yes - dry rub | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 at 13:32 | 138 at 11:12; 145 at 12:35 |
| | Piece 1 (#1) | Piece 2 (has bigger fat line) (#2) |
| Weight in (g) | 136 | 136.3 |
| Weight out (g) (fish) | 134.1 | 134.2 |
| Yield (%) (fish) | 98.6% | 98.5% |
| Weight out (g) (fish + juice) | | |
| Yield (%) (fish + juice) | | |
| Thickness (mm) | 22.5 | 22.6 |
| Width (mm) | 67.8 | 67.9 |
| Length (mm) | 109.5 | 115.9 |
| Observations | fish is sticky when comes out of freezer | |
| | no liquid when comes out of package | |
| | thick BBQy sauce | |
| Exudate amount (visual) | none | |
| Texture | good! Typical | |
| Fat between flakes | yes | |
| Pictures | yes | |
| Logger | yes | |
| Next Steps | | |
| Test number | RW 674-D68 | |
| Date | 9/6/2016 | |
| Hours logged | JB-1 | |
| Purpose of this test | test 20 mm Maple Mustard by adding fish then bringing to boil | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | ADD FISH/COVER/boil/turn off/remove at 138 | |
| Start Temp | −15 C. | |
| Cook Time/Temp | 138 at 5:37 after element off, 13:56 | 138 at 3:51 after element off, 12:10 |
| | since beginning | total time |
| | Piece 1 (#3 of MM v3) | Piece 2 (#4 of MM v3) (‘square’) |
| Weight in (g) | 145.3 | 145.9 |
| Weight out (g) (fish) | 125.9 | 124 |
| Yield (%) (fish) | 86.6% | 85.0% |
| Weight out (g) (fish + juice) | 142.7 | 142.5 |
| Yield (%) (fish + juice) | 98.2% | 97.7% |
| Thickness (mm) | 23.3 | 21.1 |
| Width (mm) | 68.8 | 84.1 |
| Length (mm) | 110.6 | 106.5 |
| Observations | sauce starts melting as soon as fish out of freezer | |
| | piece 2 heated up faster (it was on bottom . . . ) | |
| | element turned off at 8:19 | |
| | safety risk? Water boiling out of pot | |
| | sauce very watery - no squeezing out of bag required | |
| Exudate amount (visual) | none | |
| Texture | fairly typical . . . a tiny bit dry/chewy | |
| Fat between flakes | yes | |
| Pictures | yes | |
| Logger | yes. T3 = water temp T4 = air temp | |
| Next Steps | a little starch added to sauce | |
| Test number | RW 674-D67 | |
| Date | 8/6/2016 | |
| Hours logged | JB-1 | |
| Purpose of this test | 20 mm unscored | |
| Raw material | Modified Chilean | Package |
| Code | | Pouch: in-house poly |
| Dimensions | 22 mm 4.5 oz | |
| Species | Atlantic | Packaging around tray |
| Glazed | no | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 at 8:35; 145 F. at 9:00 | 138 at 6:32; 145 F. at 7:50 |
| | Piece 1 (skinnier) | Piece 2 |
| Weight in (g) | 124.7 | 128.2 |
| Weight out (g) (fish) | 113.8 | 108.7 |
| Yield (%) (fish) | 91.3% | 84.8% |
| Weight out (g) (fish + juice) | 123 | 126.9 |
| Yield (%) (fish + juice) | 98.6% | 99.0% |
| Thickness (mm) | 20.2 | 19.7 |
| Width (mm) | 55.4 | 68.6 |
| Length (mm) | 153.9 | 143.6 |
| Observations | probe shifted after taken out | warmer to start with a bit |
| | fell apart when weighing | at very botom of pot |
| | | removed >138 |
| Exudate amount (visual) | very small amount | a little in poly folds, makes shapes |
| | | similar to bubbles |
| Texture | typical | |
| Fat between flakes | yes | |
| Pictures | yes | |
| Logger | yes | |
| Next Steps | | |
| Test number | RW 674-D66 | |
| Date | 9/6/2016 | |
| Hours logged | JB-1 | |
| Purpose of this test | sauce applied fresh. Maple Mustard; scored; 20 mm | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | coil | |
| Results: | | |
| Cook Method/Instructions | boil/add fish/cover/turn off/remove at 138 | |
| Start Temp | −15 C. | |
| Cook Time/Temp | 138 at 7:09, 145 F. at 7:30? (probe error . . . ) | |
| | Piece 1 | Piece 2 |
| Weight in (g) | 151.5 | |
| Weight out (g) (fish) | 134.7 | |
| Yield (%) (fish) | 88.9% | #DIV/0! |
| Weight out (g) (fish + juice) | 147.7 | |
| Yield (%) (fish + juice) | 97.5% | #DIV/0! |
| Thickness (mm) | 23 | |
| Width (mm) | 63.8 | |
| Length (mm) | 137.7 | |
| Observations | *only one piece in pot. Coil stove boils water faster | |
| | probe error? | |
| | Flakes well | |
| | scored by Rob - different dimensions? Or just b/c scored fresh | |
| Exudate amount (visual) | not much. A tiny bit in the sauce | |
| Texture | undercooked a bit | |
| Fat between flakes | yes | |
| Pictures | yes | |
| Logger | yes | |
| Next Steps | | |
| Test number | RW 674-D65 | |
| Date | 7/6/2016 | |
| Hours logged | JB-1 hr | |
| Purpose of this test | 20 mm no sauce, remove at 138 | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 138 at 10:00 | 138 at 10:20 |
| | Piece 1 (square) | Piece 2 (long and skinny) |
| Weight in (g) | 135.1 | 133 |
| Weight out (g) (fish) | 124.4 | 112.1 |
| Yield (%) (fish) | 92.1% | 84.3% |
| Weight out (g) (fish + juice) | 137.9 | 128 |
| Yield (%) (fish + juice) | 102.1% | 96.2% |
| Thickness (mm) | 21.1 | 21.8 |
| Width (mm) | 73.2 | 54.5 |
| Length (mm) | 122.8 | 152.9 |
| Observations | warmer than usual to start b/c | removed at 10:33 |
| | wouldn't vacuum | |
| | not a good vacuum | |
| Exudate amount (visual) | some in grooves and folds of poly | |
| Texture | on the chewy side, fairly typical | |
| Fat between flakes | yes | |
| Pictures | yes | |
| Logger | yes | |
| Next Steps | | |
| Test number | RW 674-D64 | |
| Date | 7/6/2016 | |
| Hours logged | JB-1 | |
| Purpose of this test | 20 mm Maple Mustard, remove at 138 | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 138 at 12:48 | 138 at 11:48 |
| | Piece 1 | Piece 2 (higher yield) |
| Weight in (g) | 139.6 | 153.3 |
| Weight out (g) (fish) | 121.4 | 118.5 |
| Yield (%) (fish) | 87.0% | 77.3% |
| Weight out (g) (fish + juice) | 144 | 134 |
| Yield (%) (fish + juice) | 103.2% | 87.4% |
| Thickness (mm) | 22.2 | 22.4 |
| Width (mm) | 58.3 | 64.5 |
| Length (mm) | 138.8 | 139.6 |
| Observations | started a bit warmer than usual | |
| Exudate amount (visual) | very little in grooves | |
| Texture | typical | |
| Fat between flakes | yes | |
| Pictures | yes | |
| Logger | yes | |
| Next Steps | | |
| Test number | RW 674-D63 | |
| Date | 7/6/16 | |
| Hours logged | JB-1/2 | |
| Purpose of this test | repeat D52 | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 138 at 10:43; 145 at 11:33 | 138 at 12:58; 145 at 13:59 |
| | Piece 1 (tail) | Piece 2 |
| Weight in (g) | 126.2 | 139.5 |
| Weight out (g) (fish) | 109 | 121 |
| Yield (%) (fish) | 86.4% | 86.7% |
| Weight out (g) (fish + juice) | 124.6 | 135.7 |
| Yield (%) (fish + juice) | 98.7% | 97.3% |
| Thickness (mm) | 21.2 | 22 |
| Width (mm) | 95.8 | 64.8 |
| Length (mm) | 93.5 | 127.1 |
| Observations | | some of fish juice/water lost |
| Exudate amount (visual) | some in grooves/folds | a little in grooves |
| Texture | typical | |
| Fat between flakes | yes | |
| Pictures | yes | |
| Logger | yes | |
| Next Steps | | |
| Test number | RW 674-D62 | |
| Date | 7/6/2016 | |
| Hours logged | JB-1 | |
| Purpose of this test | repeat D52 (scored fish baseline - 17 mm, 2 sides, 2 directions) | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 138 at 13:50; 145 at 15:05 | 138 at 13:30; 145 at 14:47 |
| | Piece 1 | Piece 2 (‘square’) |
| Weight in (g) | 136.3 | 135 |
| Weight out (g) (fish) | 121.3 | 119.9 |
| Yield (%) (fish) | 89.0% | 88.8% |
| Weight out (g) (fish + juice) | 138.7 | 133.8 |
| Yield (%) (fish + juice) | 101.8% | 99.1% |
| Thickness (mm) | 22.1 | 22.3 |
| Width (mm) | 55.7 | 62.8 |
| Length (mm) | 140.7 | 119.02 |
| Observations | not a good vacuum seal | removed at >145 |
| Exudate amount (visual) | some where grooves of poly were | |
| Texture | typical, a little mushy | typical, a little watery |
| Fat between flakes | a little | yes |
| Pictures | yes | |
| Logger | yes | |
| Next Steps | | |
| Test number | RW 674-D61 | |
| Date | 2/6/2016 | |
| Hours logged | JB-1/2 hr | |
| Purpose of this test | test glaze from June 1 - Ginger Wasabi Soy | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 138/out at 12:26 (then probe moved); 117 at 10 min; 145 F. at 12:50 | |
| | Piece 1 | Piece 2 (D60) |
| Weight in (g) | 139.6 | |
| Weight out (g) (fish) | 111.8 | |
| Yield (%) (fish) | 80.1% | |
| Weight out (g) (fish + juice) | 135.9 | |
| Yield (%) (fish + juice) | 97.3% | |
| Thickness (mm) | 24.1 | |
| Width (mm) | 59.8 | |
| Length (mm) | 118.5 | |
| Observations | sauce starts melting a little bit | |
| | corner peeking | |
| Exudate amount (visual) | not much | |
| Texture | good | |
| Fat between flakes | yes | |
| Pictures | yes | |
| Logger | yes. Probe 2 | |
| Next Steps | increase ginger and wasabi, add a bit of salt, add visuals, thicken | |
| Test number | RW 674-D60 | |
| Date | 2/6/2016 | |
| Hours logged | JB-½ hr | |
| Purpose of this test | test glaze from June 1 - Maple Mustard | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 138/out at 12:24; 123 at 10 min; 145 F. at close to 13:00 | |
| | if no probe movement | |
| | Piece 1 | Piece 2 (D61) |
| Weight in (g) | 145.8 | |
| Weight out (g) (fish) | 127 | |
| Yield (%) (fish) | 87.1% | |
| Weight out (g) (fish + juice) | 143.6 | |
| Yield (%) (fish + juice) | 98.5% | |
| Thickness (mm) | 24.5 | |
| Width (mm) | 58.4 | |
| Length (mm) | 127.6 | |
| Observations | piece stuck to tray a bit . . . sticky | |
| | probe probably not in middle of fish - when taken out piece never | |
| | reached 145 in middle not a good vacuum | |
| Exudate amount (visual) | can see blotches through package | |
| Texture | good | |
| Fat between flakes | yes | |
| Pictures | yes | |
| Logger | yes - probe 1 | |
| Next Steps | keep sauce as is | |
| Test number | RW 674-D59 | |
| Date | 2/6/2016 | |
| Hours logged | JB-½ hr | |
| Purpose of this test | test glaze from June 1 - Miso Citrus | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 138/out at 13:39; 100 at 10 min; 145 F. at 14:30 | |
| | Piece 1 | Piece 2 (D58) |
| Weight in (g) | 144.5 | |
| Weight out (g) (fish) | 121.9 | |
| Yield (%) (fish) | 84.4% | |
| Weight out (g) (fish + juice) | 142.6 | |
| Yield (%) (fish + juice) | 98.7% | |
| Thickness (mm) | 22.1 | |
| Width (mm) | 57.8 | |
| Length (mm) | 120.4 average | |
| Observations | glaze melts very easily; very liquidy in package; sauce too runny | |
| | pepper very visible | |
| | element left on for 50 s | |
| | not completely submerged | |
| | package not visually appealing - grey colour fish (see pictures) | |
| Exudate amount (visual) | some exudate visible through package (little clumps) | |
| Texture | good | |
| Fat between flakes | yes | |
| Pictures | yes | |
| Logger | yes | |
| Next Steps | thicker sauce . . . add vinegar to bring miso out? | |
| Test number | RW 674-D58 | |
| Date | 2/6/2016 | |
| Hours logged | JB-½ hr | |
| Purpose of this test | test glaze from June 1 - BBQ | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 138/out at 12:08; 116 at 10 min; 145 F. at 12:55 | |
| | Piece 1 | Piece 2 = D59 |
| Weight in (g) | 159.1 | |
| Weight out (g) (fish) | 127.5 | |
| Yield (%) (fish) | 80.1% | |
| Weight out (g) (fish + juice) | 155 | |
| Yield (%) (fish + juice) | 97.4% | |
| Thickness (mm) | 22.7 | |
| Width (mm) | 74.6 | |
| Length (mm) | 112.7 | |
| Observations | piece not completely submerged | |
| | element left on for 50 s | |
| | probe not secure in fish | |
| Exudate amount (visual) | some exudate (very little) visible through package | |
| Texture | good | |
| Fat between flakes | yes, not a lot | |
| Pictures | yes | |
| Logger | yes | |
| Next Steps | sauce needs salt | |
| Test number | RW 674-D57 | |
| Date | 31/5/2016 | |
| Hours logged | SR-2 | |
| Purpose of this test | Test with Sauce RW 679 - Maple Mustard | |
| Raw material | Modified Chilean | Package |
| Code | | Pouch: in-house poly |
| Dimensions | 22 mm 4.5 oz | |
| Species | Atlantic Salmon | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 138 F. @ 9 min 20 sec | |
| | Piece 1 - #1 in RW 679 | Piece 2 |
| Weight in (g) | | piece 2 in pot was D-56 |
| Weight out (g) (fish) | | |
| Yield (%) (fish) | | |
| Weight out (g) (fish + juice) | | |
| Yield (%) (fish + juice) | | |
| Thickness (mm) | | |
| Width (mm) | | |
| Length (mm) | | |
| Observations | Silghtly globby sauce | |
| | Nice mustard, very mild maple | |
| | Slightly difficult to squeeze sauce out of pouch | |
| Exudate amount (visual) | Very minimal - mostly in scores and where two sides of poly meet | |
| Texture | typical | |
| Fat between flakes | Not noticable, not dry | |
| Pictures | yes | |
| Logger | yes T1 | |
| Next Steps | Test this flavor in Date night | |
| Test number | RW 674-D56 | |
| Date | 31/5/2016 | |
| Hours logged | SR-1 | |
| Purpose of this test | Test with Sauce RW 680 - Teriyaki Lime Cilantro | |
| Raw material | Modified Chilean | Package |
| Code | | Pouch: in-house poly |
| Dimensions | 22 mm 4.5 oz | |
| Species | Atlantic Salmon | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. F22 | |
| Cook Time/Temp | 138 F. @ 9 min 18 sec | |
| | Piece 1 - #1 in RW 680 | Piece 2 |
| Weight in (g) | | piece 2 in pot was D-57 |
| Weight out (g) (fish) | | |
| Yield (%) (fish) | | |
| Weight out (g) (fish + juice) | | |
| Yield (%) (fish + juice) | | |
| Thickness (mm) | | |
| Width (mm) | | |
| Length (mm) | | |
| Observations | Warmed slightly waiting for second piece to be prepared | |
| | No objections to sauce consistancy | |
| | Flavor - some found it to be too strong of cilantro with an after-taste | |
| | - both chemical and green tea taste noted | |
| | - teriyaki is mild | |
| Exudate amount (visual) | None | |
| Texture | typical | |
| Fat between flakes | Not noticable, not dry | |
| Pictures | yes | |
| Logger | yes T2 | |
| Next Steps | Test this flavor in Date night | |
| Test number | RW 674-D55 | |
| Date | 31/5/2016 | |
| Hours logged | JB-1 | |
| Purpose of this test | repeat D54 w/ roasted garlic glaze | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. (not quite - out of freezer for a while and twice vacuum sealed) | |
| Cook Time/Temp | 118 at 10 min; 138 at 11:57; 145 at | 118 at 10 min; 138 at 12:03; 145 at |
| | 12:50 | 13:10 |
| | Piece 1 (triangle) | Piece 2 |
| Weight in (g) | 141.6 | 152.7 |
| Weight out (g) (fish) | 119.2 | 128.7 |
| Yield (%) (fish) | 84.2% | 84.3% |
| Weight out (g) (fish + juice) | 138.1 | 148.6 |
| Yield (%) (fish + juice) | 97.5% | 97.3% |
| Thickness (mm) | 23.6 | 24.6 |
| Width (mm) | 75.2 | 59.1 |
| Length (mm) | 96.6 | 137.4 |
| Observations | some of glaze turned to liquid by the time package went into pot | |
| | both bage had a bit of condensation in them by the end | |
| Exudate amount (visual) | a very little in grooves | |
| Texture | typical | |
| Fat between flakes | not a lot, doesn't flake well | yes |
| Pictures | yes | |
| Logger | yes | |
| Next Steps | | |
| Test number | RW 674-D54 | |
| Date | 31/5/2016 | |
| Hours logged | JB-1 hr | |
| Purpose of this test | test glazed scored salmon (17 mm, 2 sides, | |
| | 2 directions; Creamy Dill 30/5/2016) | |
| Raw material | Modified Chilean | Package |
| Code | | Pouch: in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 97 at 10 min; 138 at 14:42; | 97 at 10 min; 138 at 14:22; |
| | 145 F. at 17:10 | 145 F. at 15:30 |
| | Piece 1 (square) | Piece 2 (rectangle) |
| Weight in (g) | 151.9 | 131.5 |
| Weight out (g) (fish) | 126.3 | 110.5 |
| Yield (%) (fish) | 83.1% | 84.0% |
| Weight out (g) (fish + juice) | 149.9 | 129 |
| Yield (%) (fish + juice) | 98.7% | 98.1% |
| Thickness (mm) | 25 | 23.6 |
| Width (mm) | 77.9 | 55.5 |
| Length (mm) | 112.8 | 128.6 |
| Observations | glaze starts to melt while handling while measuring | |
| | pouch 2 left in water until 1 reached 138 F., i.e. removed when it was | |
| | at least 139 F. | |
| | vacuum not completely tight - condensation in package | |
| | corner of pouch 1 above water | |
| Exudate amount (visual) | some, in grooves, clump on bottom | |
| Texture | a bit mushy, typical | typical |
| Fat between flakes | some | |
| Pictures | yes | |
| Logger | yes | |
| Next Steps | | |
| Test number | RW 674-D53 | |
| Date | 26/5/2016 | |
| Hours logged | JB-1 hr | |
| Purpose of this test | repeat D52 - scored fish baseline | |
| | (17 mm, 2 sides, 2 directions, JB 19/5/2016) | |
| Raw material | Modified Chilean | Package |
| Code | | Pouch in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/instructions | boil/add fish/cover/turn off | |
| Start Temp | −15 C. | |
| Cook Time/Temp | 145 F. @ 12:02 | |
| | Piece 1 | Piece 2 |
| Weight in (g) | 127.8 | 106.8 |
| Weight out (g) (fish) | 113.4 | 95.8 |
| Yield (%) (fish) | 88.7% | 89.7% |
| Weight out (g) (fish + juice) | 126.2 | 106 |
| Yield (%) (fish + juice) | 98.7% | 99.3% |
| Thickness (mm) | 21.8 | 21 |
| Width (mm) | 49.2 | 45.9 |
| Length (mm) | | |
| Observations | room temp: ~81.5 F. | |
| Exudate amount (visual) | fair bit where folds in poly were | |
| Texture | not oily . . . watery/dry | |
| Fat between flakes | yes. Peels off a bit | |
| Pictures | yes. Piece 1 on left | |
| Logger | yes. Piece 1 = probe | |
| Next Steps | repeat | |
| Test number | RW 674-D52 | |
| Date | 26/5/2016 | |
| Hours logged | JB-1 hr | |
| Purpose of this test | scored fish baseline (17 mm, 2 sides, 2 directions, JB 19/5/2016) | |
| Raw material | Modified Chilean | Package |
| Code | | Pouch in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 145 F. @ 11:30 | |
| | Piece 1 | Piece 2 |
| Weight in (g) | 127.6 | 122.8 |
| Weight out (g) (fish) | 108.6 | 110.1 |
| Yield (%) (fish) | 85.1% | 89.7% |
| Weight out (g) (fish + juice) | 126.7 | 121.6 |
| Yield (%) (fish + juice) | 99.3% | 99.0% |
| Thickness (mm) | 21.8 | 21.3 |
| Width (mm) | 76.7 | 56.5 |
| Length (mm) | 103.4 | 118.6 |
| Observations | room temp: ~81 F. | |
| | doesn't flake well | |
| Exudate amount (visual) | on sides (poly folds) and in grooves, also between flakes | |
| Texture | a little chewy | |
| Fat between flakes | yes, a bit | |
| Pictures | yes. Piece 1 on left | |
| Logger | yes | |
| Next Steps | repeat | |
| Test number | RW 674-D51 | |
| Date | 25/5/2016 | |
| Hours logged | JB-1 hr | |
| Purpose of this test | repeat D50 (remove at 138 F.) | |
| Raw material | Modified Chilean | Package |
| Code | | Pouch in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 138 F. at 9:36, 145 at 10:10 | |
| | Piece 1 | Piece 2 |
| Weight in (g) | 127.1 | 125.5 |
| Weight out (g) (fish) | 114.6 | 116.8 |
| Yield (%) (fish) | 90.2% | 93.1% |
| Weight out (g) (fish + juice) | 125.6 | 124.5 |
| Yield (%) (fish + juice) | 98.8% | 99.2% |
| Thickness (mm) | 22 | 35 |
| Width (mm) | 68.2 | 58.6 |
| Length (mm) | 117.6 | 90.3 |
| Observations | by the time fish out of pot, already at 141 F. | |
| | room temp: 73.4 F. | |
| Exudate amount (visual) | some, on bottom/sides, where poly wrinkles are | |
| Texture | typical, very slightly dry | |
| Fat between flakes | yes | |
| Pictures | yes. Probe piece on left | |
| Logger | yes | |
| Next Steps | | |
| Test number | RW 674-D50 | |
| Date | 25/5/2016 | |
| Hours logged | JB 1 | |
| Purpose of this test | remove fish at 138 F. and observe temperature | |
| Raw material | Modified Chilean | Package |
| Code | | Pouch in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/acid fish/cover/turn off | |
| Start Temp | −15 C. | |
| Cook Time/Temp | 138 F. at 12:44, 145 at 13:20 | |
| | Piece 1 | Piece 2 |
| Weight in (g) | 138.3 | 120 |
| Weight out (g) (fish) | 122.2 | 108.2 |
| Yield (%) (fish) | 88.4% | 90.2% |
| Weight out (g) (fish + juice) | 136.8 | 119 |
| Yield (%) (fish + juice) | 98.9% | 99.2% |
| Thickness (mm) | 23.2 | 29.2 |
| Width (mm) | 62.9 | 52.3 |
| Length (mm) | 118.5 | 104.7 |
| Observations | room temp: 72.8 F. | |
| | one corner floating | |
| Exudate amount (visual) | a little; on sides/bottom | |
| Texture | typical, a bit on the dry side | |
| Fat between flakes | yes | |
| Pictures | yes. Probe piece on left | |
| Logger | yes | |
| Next Steps | repeat | |
| Test number | RW 674-D49 | |
| Date | 24/5/2016 | |
| Hours logged | JB-1 hr | |
| Purpose of this test | repeat D-48 | |
| Raw material | Modified Chilean | Package |
| Code | | Pouch in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 145 F. @ never reached | |
| | Piece 1 | Piece 2 |
| Weight in (g) | 117.6 | 130.2 |
| Weight out (g) (fish) | 108.2 | 120 |
| Yield (%) (fish) | 92.0% | 92.2% |
| Weight out (g) (fish + juice) | 108.2 | 129.3 |
| Yield (%) (fish + juice) | 92.0% | 99.3% |
| Thickness (mm) | 21.7 | 28.2 |
| Width (mm) | 44 | 49.4 |
| Length (mm) | 148.5 | 123.9 |
| Observations | 135 at 9:22; room temp 75 F. | |
| | fish flakes apart very easily | |
| Exudate amount (visual) | hardly any | |
| Texture | typical, a bit watery | |
| Fat between flakes | yes | |
| Pictures | yes. Probe piece on right | |
| Logger | yes | |
| Next Steps | | |
| Test number | RW 674-D48 | |
| Date | May 24, 2016 | |
| Hours logged | JB-1 hr | |
| Purpose of this test | test temp. rise after fish removed from pot, take out at 135 F. | |
| Raw material | Modified Chilean | Package |
| Code | | Pouch in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 145 F. @ 13:30 | |
| | Piece 1 | Piece 2 |
| Weight in (g) | 134.1 | 128.6 |
| Weight out (g) (fish) | 123.5 | 117.9 |
| Yield (%) (fish) | 92.1% | 91.7% |
| Weight out (g) (fish + juice) | 132.8 | 128.4 |
| Yield (%) (fish + juice) | 99.0% | 99.8% |
| Thickness (mm) | 21.9 | 30.8 |
| Width (mm) | 60.2 | 54 |
| Length (mm) | 125.8 | 95.2 |
| Observations | 135 at 10:52; room temp 74 F. | |
| | temp goes down a bit once fish taken out/probe moves around, | |
| | then goes back up | |
| Exudate amount (visual) | a little | |
| Texture | typical | |
| Fat between flakes | yes | |
| Pictures | yes | |
| Logger | yes | |
| Next Steps | repeat | |
| Test number | RW 674-D47 | |
| Date | May 24, 2016 | |
| Hours logged | JB-1 hr | |
| Purpose of this test | test temp. rise after fish removed from pot rep 2 | |
| Raw material | Modified Chilean | Package |
| Code | | Pouch in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 145 F. @ 13:51 | |
| | Piece 1 | Piece 2 |
| Weight in (g) | 132.8 | 127.1 |
| Weight out (g) (fish) | 120.2 | 114.2 |
| Yield (%) (fish) | 90.5% | 89.9% |
| Weight out (g) (fish + juice) | 131.4 | 127.3 |
| Yield (%) (fish + juice) | 98.9% | 100.2% |
| Thickness (mm) | 22.1 | 26.6 |
| Width (mm) | 68.1 | 62 |
| Length (mm) | 108.5 | 109.2 |
| Observations | corner floating | |
| Exudate amount (visual) | a little. Forms along ridges of poly bag | |
| Texture | typical, chewy/dry in some parts | |
| Fat between flakes | yes | |
| Pictures | yes | |
| Logger | yes | |
| Next Steps | next test: remove at 135 F. | |
| Test number | RW 674-D46 | |
| Date | May 24, 2016 | |
| Hours logged | JB 1 hr | |
| Purpose of this test | test temp. rise after fish removed from pot | |
| Raw material | Modified Chilean | Package |
| Code | | Pouch in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 145 F. @ 12:56 Code | Pouch in-house poly |
| | Piece 1 | Piece 2 |
| Weight in (g) | 135 | 120.9 |
| Weight out (g) (fish) | 121.5 | 105.4 |
| Yield (%) (fish) | 90.0% | 87.2% |
| Weight out (g) (fish + juice) | 133.5 | 119.7 |
| Yield (%) (fish + juice) | 98.9% | 99.0% |
| Thickness (mm) | 22.3 | 18.2 |
| Width (mm) | 60.7 | 67.2 |
| Length (mm) | 119.6 | 137.8 |
| Observations | corner floating | |
| | fish put onto plate at room temp (70 F.) | |
| Exudate amount (visual) | some | |
| Texture | typical, a little chewy | |
| Fat between flakes | yes | |
| Pictures | yes | |
| Logger | yes | |
| Next Steps | look at datalogger to see if time can be shortened | |
| | try removing at 135 F. | |
| Test number | RW 674-D45 | |
| Date | May 20, 2016 | |
| Hours logged | 1 | |
| Purpose of this test | Continue testing - Bring back to hard rolling boil after adding fish, | |
| | 22 mm, in-house poly/change from last test to eliminate lid gap | |
| | Target to reduce cook time to 10 min. | |
| Raw material | Modified Chilean | Package |
| Code | | Pouch in-house poly |
| Dimensions | 22 mm 4.5 oz | |
| Species | Atlantic | Packaging around tray |
| Glazed | no | Other package info |
| Skin on/off | off | |
| Cooking method | | |
| Pot description | non-stick pot | |
| Cover type | glass | |
| Heat setting | boil | |
| Water quantity | 8 cups | |
| Stove type | coil | |
| Results: | | |
| Cook Method/Instructions | boil to hard rolling boil/add fish/cover/bring back to hard boil/turn off heat | |
| Start Temp | −15 C. | |
| Cook Time/Temp | 145 F. @ 12 m 49 s | |
| | Pot returned to boil @ 43 sec | |
| | Piece 1 | Piece 2 |
| Weight in (g) | 125.9 | 129.7 |
| Weight out (g) (fish) | 112.4 | 112.5 |
| Yield (%) (fish) | 89.28 | 86.74 |
| Thickness (mm) | 22.58 | 22.26 |
| Width (mm) | 62.3 | 50.26 |
| Length (mm) | 104.3 | 136.76 |
| Observations | | |
| Exudate amount (visual) | mimimal | |
| Texture | typical | |
| Fat between flakes | slight | |
| Pictures | yes | |
| Logger | yes | |
| Next Steps | | |
| Test number | RW 674-D44 | |
| Date | May 20, 2016 | |
| Hours logged | 2 | |
| Purpose of this test | Test Bring back to hard rolling boil after adding fish. | |
| | 22 mm, in-house poly/change from last test to eliminate lid gap | |
| | Target to reduce cook time to 10 min. | |
| Raw material | Modified Chilean | Package |
| Code | | Pouch in-house poly |
| Dimensions | 22 mm 4.5 oz | |
| Species | Atlantic | Packaging around tray |
| Glazed | no | Other package info |
| Skin on/off | off | |
| Cooking method | | |
| Pot description | non-stick pot | |
| Cover type | glass | |
| Heat setting | boil | |
| Water quantity | 8 cups | |
| Stove type | coil | |
| Results: | | |
| Cook Method/Instructions | boil to hard rolling boil/add fish/cover/bring back to hard boil/turn off heat | |
| Start Temp | −15 C. | |
| Cook Time/Temp | 145 F. @ 9 m 7 s | |
| | Pot returned to boil @ 34 sec | |
| | Piece 1 | Piece 2 |
| Weight in (g) | 124.7 | 124.6 |
| Weight out (g) (fish) | 112.4 | 116.4 |
| Yield (%) (fish) | 90.14 | 93.42 |
| Thickness (mm) | 21.3 | 21.8 |
| Width (mm) | 75.59 | 57.48 |
| Length (mm) | 117.9 | 125.5 |
| Observations | | |
| Exudate amount (visual) | slight on 1pc, almost nil on other | |
| Texture | typical | |
| Fat between flakes | slight on tail/probe pc but more on other | |
| Pictures | yes | |
| Logger | yes | |
| Next Steps | | |
| Test number | RW 674-D43 | |
| Date | May 19, 2016 | |
| Hours logged | 1 | |
| Purpose of this test | Test Bring back to boil after adding fish. | |
| | 22 mm, in-house poly/change from last test to eliminate lid gap | |
| | Target to reduce cook time to 10 min. | |
| Raw material | Modified Chilean | Package |
| Code | | Pouch in-house poly |
| Dimensions | 22 mm 4.5 oz | |
| Species | Atlantic | Packaging around tray |
| Glazed | no | Other package info |
| Skin on/off | off | |
| Cooking method | | |
| Pot description | non-stick pot | |
| Cover type | glass | |
| Heat setting | boil | |
| Water quantity | 8 cups | |
| Stove type | coil | |
| Results: | | |
| Cook Method/Instructions | boil/add fish/cover/bring back to boil/turn off heat | |
| Start Temp | −15 C. | |
| Cook Time/Temp | 145 F. @ 11 m 17 s | |
| | Pot returned to boil @ 53 sec | |
| | Piece 1 | Piece 2 |
| Weight in (g) | 138.9 | 120.2 |
| Weight out (g) (fish) | 126.7 | 110.9 |
| Yield (%) (fish) | 91.22 | 92.26 |
| Thickness (mm) | 21.3 | 22.88 |
| Width (mm) | 53.64 | 56.67 |
| Length (mm) | 123.03 | 136.91 |
| Observations | Pot returned to boil at 53 seconds | |
| | water was at light boil with steam (bubbles break surface) | |
| | from memory, coil range appears to bring pot back to boil faster - verify? | |
| Exudate amount (visual) | almost nil | |
| Texture | typical | |
| Fat between flakes | yes | |
| Pictures | yes | |
| Logger | yes | |
| Next Steps | | |
| Test number | RW 674-D42 | |
| Date | May 19, 2016 | |
| Hours logged | 2 | |
| Purpose of this test | Test Bring back to boil after adding fish. | |
| | 22 mm, in-house poly | |
| | Target to reduce cook time to 10 min. | |
| Raw material | Modified Chilean | Package |
| Code | | Pouch in-house poly |
| Dimensions | 22 mm 4.5 oz | |
| Species | Atlantic | Packaging around tray |
| Glazed | no | Other package info |
| Skin on/off | off | |
| Cooking method | | |
| Pot description | non-stick pot | |
| Cover type | glass | |
| Heat setting | boil | |
| Water quantity | 8 cups | |
| Stove type | coil | |
| Results: | | |
| Cook Method/Instructions | boil/add fish/cover/bring back to boil/turn off heat | |
| Start Temp | −15 C. | |
| Cook Time/Temp | 145 F. @ 10 m 29 s | |
| | Piece 1 | Piece 2 |
| Weight in (g) | 127.8 | 133.8 |
| Weight out (g) (fish) | 116.9 | 120.5 |
| Yield (%) (fish) | 91.47 | 90.06 |
| Thickness (mm) | 21.59 | 21.11 |
| Width (mm) | 77.41 | 74.99 |
| Length (mm) | 88.09 | 111.74 |
| Observations | Pot returned to boil at 20 seconds | |
| | Should arrange probe through lid to eliminate gap | |
| | water was at full hard boil with lots of steam | |
| Exudate amount (visual) | very minimum | |
| Texture | typical | |
| Fat between flakes | yes | |
| Pictures | yes | |
| Logger | yes | |
| Next Steps | Should arrange probe through lid to eliminate gap | |
| Test number | RW 674-D41 | |
| Date | May 12, 2016 | |
| Hours logged | 45 mins | |
| Purpose of this test | baseline testing, 22 mm, 145, only one piece of salmon to try and cook | |
| | completely in retort | |
| Raw material | Modified Chilean | Package |
| Code | | Pouch gold Al retort bag |
| Dimensions | 22 mm 4.5 oz | |
| Species | Atlantic | Packaging around tray |
| Glazed | no | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 145 F. @ 16 m 42 s | |
| | Piece 1 | |
| Weight in (g) | 114.3 | |
| Weight out (g) (fish) | 103.4 | |
| Yield (%) (fish) | 90.46369204 | |
| Thickness (mm) | 20.3 | |
| Width (mm) | 58.2 | |
| Length (mm) | 125.1 | |
| Observations | probe was very likely not in center of fish; salmon cooked | |
| | properly and mostly evenly when only one piece in pot; only very | |
| | slightly pink right next to the fat line | |
| Exudate amount (visual) | fair bit on both sides | |
| Texture | typical | |
| Fat between flakes | yes | |
| Pictures | yes | |
| Logger | yes | |
| Next Steps | | |
| Test number | RW 674-D40 | |
| Date | May 12, 2016 | |
| Hours logged | 1 hr | |
| Purpose of this test | baseline testing, 22 mm, 145, RETORT BAG | |
| Raw material | Modified Chilean | Package |
| Code | | Pouch 1. gold Al retort bag |
| Dimensions | 22 mm 4.5 oz | 2. poly |
| Species | Atlantic | Packaging around tray |
| Glazed | no | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 145 F. @ 15 m 25 s | |
| | interior temp of fish 2 in poly bag at this time = ~160 F. | |
| | Piece 1 | Piece 2 |
| Weight in (g) | 137.2 | 129.4 |
| Weight out (g) (fish) | 126.9 | 113.8 |
| Yield (%) (fish) | 92.49271137 | 87.94435858 |
| Thickness (mm) | 22.12 | 22.01 |
| Width (mm) | 58.8 | 58.2 |
| Length (mm) | 128.1 | 125.8 |
| Observations | can't vacuum seal retort bag because not enough heat | |
| | slow to heat up at end | |
| | probe not necessarily in the middle; bag not completely in water | |
| | piece 1 was very pink in middle around fat line, probably because | |
| | piece 2 was resting against it there | |
| Exudate amount (visual) | a fair bit on piece 1, not as much on piece 2 | |
| Texture | piece 2 was typical but a bit on the tough side; piece 1 was typical | |
| | in the cooked parts and undercooked in the pink part | |
| Fat between flakes | yes but not much on piece 1 | |
| Pictures | yes | |
| Logger | yes | |
| Next Steps | | |
| Test number | RW 674-D39 | |
| Date | May 11, 2016 | |
| Hours logged | ½ hr | |
| Purpose of this test | baseline testing, 22 mm, 145, CHEESECLOTH | |
| Raw material | Modified Chilean | Package Cheesecloth |
| Code | | Pouch |
| Dimensions | 22 mm 4.5 oz | |
| Species | Atlantic | Packaging around tray |
| Glazed | no | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 145 F. @ see datalogger | |
| | Piece 1 | Piece 2 |
| Weight in (g) | 111.4 | 111.5 |
| Weight out (g) (fish) | 91.9 | 93.3 |
| Yield (%) (fish) | 82.49551167 | 83.67713004 |
| Thickness (mm) | 20.9 | 20.1 |
| Width (mm) | 46.7 | 48.4 |
| Length (mm) | 139.5 | 134.6 |
| Observations | salmon was taken out after 16 minutes (177 F.) | |
| Exudate amount (visual) | some on bottoms of pieces (small amount) | |
| Texture | a little bit tough because it was overcooked | |
| Fat between flakes | yes | |
| Pictures | no | |
| Logger | yes | |
| Next Steps | | |
| Test number | RW 674-D38 | |
| Date | May 11, 2016 | |
| Hours logged | ½ hr | |
| Purpose of this test | baseline testing, 22 mm, 145, CHEESECLOTH | |
| Raw material | Modified Chilean | Package Cheesecloth |
| Code | | Pouch |
| Dimensions | 22 mm 4.5 oz | |
| Species | Atlantic | Packaging around tray |
| Glazed | no | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 145 F. @ 11 m 0 s | |
| | Piece 1 | Piece 2 |
| Weight in (g) | 125.4 | 126.4 |
| Weight out (g) (fish) | 111.7 | 111.2 |
| Yield (%) (fish) | 89.07496013 | 87.97468354 |
| Thickness (mm) | 21.4 | 19.1 |
| Width (mm) | 94.5 | 95.1 |
| Length (mm) | 78.1 | 95.4 |
| Observations | cheesecloth (or method of cooking) makes surface of | |
| | salmon have lines . . . see picture | |
| Exudate amount (visual) | almost none on one, a little bit on piece 2 | |
| Texture | typical | |
| Fat between flakes | yes | |
| Pictures | yes | |
| Logger | yes | |
| Next Steps | | |
| Test number | RW 674-D37 | |
| Date | May 11, 2016 | |
| Hours logged | 1 hr | |
| Purpose of this test | baseline testing, 22 mm, 145, CHEESECLOTH | |
| Raw material | Modified Chilean | Package Cheesecloth |
| Code | | Pouch |
| Dimensions | 22 mm 4.5 oz | |
| Species | Atlantic | Packaging around tray |
| Glazed | no | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 145 F. @ 9 m 47 s | |
| | Piece 1 | Piece 2 |
| Weight in (g) | 130.7 | 112.4 |
| Weight out (g) (fish) | 116.1 | 99.5 |
| Yield (%) (fish) | 88.82938026 | 88.52313167 |
| Thickness (mm) | 19.6 | 22.1 |
| Width (mm) | 47.8 | 44.7 |
| Length (mm) | 160.4 | 143.7 |
| Observations | there could be bits of cheesecloth still stuck to the salmon | |
| Exudate amount (visual) | none | |
| Texture | typical | |
| Fat between flakes | yes | |
| Pictures | yes | |
| Logger | yes | |
| Next Steps | | |
| Test number | RW 674-D36 | |
| Date | May 11, 2016 | |
| Hours logged | ½ hr | |
| Purpose of this test | baseline testing, 22 mm, poly, 145, GLAZE | |
| Raw material | Modified Chilean | Package |
| Code | | Pouch in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 145 F. @ 11 m 37 s | |
| | Piece 1 | Piece 2 |
| Weight in (g) | 126 | 135.1 |
| Weight out (g) (fish) | 109.6 | 114.2 |
| Yield (%) (fish) | 86.98412698 | 84.52997779 |
| Weight out (g) (fish + juice) | 129.2 | 132.2 |
| Yield (%) (fish + juice) | 102.5396825 | 97.85344189 |
| Thickness (mm) | 20.5 | 22.2 |
| Width (mm) | 59.7 | 60.7 |
| Length (mm) | 126.4 | 130.6 |
| Observations | | |
| Exudate amount (visual) | none | |
| Texture | typical | |
| Fat between flakes | yes | |
| Pictures | yes | |
| Logger | yes | |
| Next Steps | | |
| Test number | RW 674-D35 | |
| Date | 5/11/2016 | |
| Hours logged | ½ hr | |
| Purpose of this test | baseline testing, 22 mm, poly, 145, GLAZE | |
| Raw material | Modified Chilean | Package |
| Code | | Pouch in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 145 F. @ 10 m + ~30 s (check datalogger) | |
| | Piece 1 | Piece 2 |
| Weight in (g) | 131.4 | 148.8 |
| Weight out (g) (fish) | 111.5 | 124.1 |
| Yield (%) (fish) | 84.85540335 | 83.40053763 |
| Weight out (g) (fish + juice) | 128.9 | 146.4 |
| Yield (%) (fish + juice) | 98.09741248 | 98.38709677 |
| Thickness (mm) | 21.97 | 21.67 |
| Width (mm) | 58.4 | 65.16 |
| Length (mm) | 146.23 | 144.68 |
| Observations | one corner floated | |
| Exudate amount (visual) | none on 1, 2 had some in juice and a little on piece itself | |
| Texture | 1 was typical, 2 had a little bit of a ‘non-cooked’ texture, maybe | |
| | because of exudate | |
| Fat between flakes | yes | |
| Pictures | yes | |
| Logger | yes | |
| Next Steps | | |
| Test number | RW 674-D34 | |
| Date | 5/11/2016 | |
| Hours logged | ½ hr | |
| Purpose of this test | baseline testing, 22 mm, poly, 145, GLAZE | |
| Raw material | Modified Chilean | Package |
| Code | | Pouch in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 145 F. @ 11 m 40 s | |
| | Piece 1 | Piece 2 |
| Weight in (g) | 144.7 | 139.3 |
| Weight out (g) (fish) | 125.4 | 121.7 |
| Yield (%) (fish) | 86.66205943 | 87.36539842 |
| Weight out (g) (fish + juice) | 142.8 | 138.1 |
| Yield (%) (fish + juice) | 98.68693849 | 99.13854989 |
| Thickness (mm) | 21 | 22.9 |
| Width (mm) | 70.2 | 60.8 |
| Length (mm) | 110.2 | 123.6 |
| Observations | (these fish were in the freezer after vacuum packed for a while) | |
| | piece 1 broke apart with handling | |
| Exudate amount (visual) | none | |
| Texture | typical | |
| Fat between flakes | yes | |
| Pictures | yes | |
| Logger | yes | |
| Next Steps | | |
| Test number | RW 674-D33 | |
| Date | 5/11/2016 | |
| Hours logged | ½ hr | |
| Purpose of this test | baseline testing, 22 mm, poly, 145, GLAZE | |
| Raw material | Modified Chilean | Package |
| Code | | Pouch in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 145 F. @ ~12 min (check datalogger) | |
| | Piece 1 | Piece 2 |
| Weight in (g) | 138.7 | 122.9 |
| Weight out (g) (fish) | 118.4 | 101.7 |
| Yield (%) (fish) | 85.36409517 | 82.75020342 |
| Weight out (g) (fish + juice) | 134.6 | 121.3 |
| Yield (%) (fish + juice) | 97.04397981 | 98.69812856 |
| Thickness (mm) | 22.4 | 21.5 |
| Width (mm) | 51.9 | 40.7 |
| Length (mm) | 136.2 | 164.1 |
| Observations | both pieces fell apart with handling | |
| Exudate amount (visual) | none | |
| Texture | typical | |
| Fat between flakes | yes | |
| Pictures | yes | |
| Logger | yes | |
| Next Steps | | |
| Test number | RW 674-D32 | |
| Date | 5/11/2016 | |
| Hours logged | 1 hr | |
| Purpose of this test | baseline testing, 22 mm, poly, 145, GLAZE | |
| Raw material | Modified Chilean | Package |
| Code | | Pouch in-house poly |
| Dimensions | 22 mm 4.5 oz | |
| Species | Atlantic | Packaging around tray |
| Glazed | yes | Other package info |
| Skin on/off | off | |
| Cooking method | | |
| Pot description | non-stick pot | |
| Cover type | glass | |
| Heat setting | boil then turn off | |
| Water quantity | 8 cups | |
| Stove type | flat-top | |
| Results: | | |
| Cook Method/Instructions | boil/add fish/cover/turn off | |
| Start Temp | −15 C. | |
| Cook Time/Temp | 145 F. @ 10 m 50 s | |
| | Piece 1 | Piece 2 |
| Weight in (g) | 135.4 | 135 |
| Weight out (g) (fish) | 118.6 | 115 |
| Yield (%) (fish) | 87.59231905 | 85.18518519 |
| Weight out (g) (fish + juice) | 132.8 | 133 |
| Yield (%) (fish + juice) | 98.07976366 | 98.51851852 |
| Thickness (mm) | 20.2 | 21.6 |
| Width (mm) | 74.07 | 77.8 |
| Length (mm) | 97.02 | 107.1 |
| Observations | Glaze starts melting in vaccum sealer | |
| Exudate amount (visual) | a small amount on piece 2, none on piece 1 | |
| Texture | typical | |
| Fat between flakes | yes | |
| Pictures | yes | |
| Logger | yes | |
| Next Steps | | |
| Test number | RW 674-D31 | |
| Date | 5/10/2016 | |
| Hours logged | JB-0.5 hrs | |
| Purpose of this test | baseline testing, 22 mm, poly, 145 F. | |
| Raw material | | Package |
| Code | Modified Chilean | Pouch in-house poly |
| Dimensions | 22 mm 4.5 oz | |
| Species | Atlantic Salmon | Packaging around tray |
| Glazed | no | Other package info |
| Skin on/off | off | |
| Cooking method | | |
| Pot description | non stick pot | |
| Cover type | clear glass | |
| Heat setting | boil then turn off | |
| Water quantity | 8 cups | |
| Stove type | flat top | |
| Results: | | |
| Cook Method/instructions | bring water to boil, add fish, cover, turn off burner | |
| Start temp | −15 C. | |
| Cook time/temp | 145 F. @ 10 m 10 s | |
| | piece w/probe | piece 2 |
| Weight in (g) | 127.5 | 124.8 |
| Weight out (g) | 111.4 | 114.3 |
| Yield (%) | 87.37 | 91.59 |
| Thickness (mm) | 20.60 | 21.58 |
| Width (mm) | 49.3 | 51.6 |
| Length (mm) | 134.3 | 143.4 |
| Volume (mm3) | 136392.39 | 159679.92 |
| Observations | | |
| Exudate amount (visual) | almost none | |
| Texture | typical mouth feel, nice fat | |
| Fat between flakes | yes | |
| Pictures | yes | |
| Logger | yes | |
| Next Steps | | |
| Test number | RW 674-D30 | |
| Date | 5/10/2016 | |
| Hours logged | JB-0.5 hrs | |
| Purpose of this test | baseline testing, 22 mm, poly, 145 F. | |
| Raw material | | Package |
| Code | Modified Chilean | Pouch in-house poly |
| Dimensions | 22 mm 4.5 oz | |
| Species | Atlantic Salmon | Packaging around tray |
| Glazed | no | Other package info |
| Skin on/off | off | |
| Cooking method | | |
| Pot description | non stick pot | |
| Cover type | clear glass | |
| Heat setting | boil then turn off | |
| Water quantity | 8 cups | |
| Stove type | flat top | |
| Results: | | |
| Cook Method/instructions | bring water to boil, add fish, cover, turn off burner | |
| Start temp | −15 c. | |
| Cook time/temp | 145 F. @ 12 m 33 s | |
| | piece w/probe | piece 2 |
| Weight in (g) | 135.6 | 129.7 |
| Weight out (g) | 120.8 | 116.3 |
| Yield (%) | 89.09 | 89.67 |
| Thickness (mm) | 20.46 | 22.12 |
| Width (mm) | 67.5 | 65.8 |
| Length (mm) | 108.1 | 108.8 |
| Volume (mm3) | 149291.51 | 158357.96 |
| Observations | Some gapping in piece 1 | |
| Exudate amount (visual) | almost none | |
| Texture | typical mouth feel, nice fat | |
| Fat between flakes | yes | |
| Pictures | yes | |
| Logger | yes | |
| Next Steps | | |
| Test number | RW 674-D29 | |
| Date | 5/10/2016 | |
| Hours logged | JB-0.5 hrs | |
| Purpose of this test | baseline testing, 22 mm, poly, 145 F. | |
| Raw material | | Package |
| Code | Modified Chilean | Pouch in-house poly |
| Dimensions | 22 mm 4.5 oz | |
| Species | Atlantic Salmon | Packaging around tray |
| Glazed | no | Other package info |
| Skin on/off | off | |
| Cooking method | | |
| Pot description | non stick pot | |
| Cover type | clear glass | |
| Heat setting | boil then turn off | |
| Water quantity | 8 cups | |
| Stove type | flat top | |
| Results: | | |
| Cook Method/instructions | bring water to boil, add fish, cover, turn off burner | |
| Start temp | −15 C. | |
| Cook time/temp | 145 F. @ 12 m 15 s | |
| | piece w/probe | piece 2 |
| Weight in (g) | 133.9 | 123.9 |
| Weight out (g) | 117.3 | 109.1 |
| Yield (%) | 87.60 | 88.05 |
| Thickness (mm) | 21.04 | 21.33 |
| Width (mm) | 52.4 | 52.9 |
| Length (mm) | 151.25 | 146.8 |
| Volume (mm3) | 166752.52 | 165642.81 |
| Observations | an end of piece 1 broke off as sliding out of package. Piece 2 fell | |
| | apart when turning over for picture. | |
| Exudate amount (visual) | hardly any on both pieces | |
| Texture | typical mouth feel, nice fat | |
| Fat between flakes | yes | |
| Pictures | yes | |
| Logger | yes. Water probe not placed in water until ~8 mins into test | |
| Next Steps | | |
| Test number | RW 674-D28 | |
| Date | 5/10/2016 | |
| Hours logged | JB-1 hr | |
| Purpose of this test | baseline testing, 22 mm, poly, 145 F., square pieces | |
| Raw material | | Package |
| Code | Modified Chilean | Pouch in-house poly |
| Dimensions | 22 mm 4.5 oz | |
| Species | Atlantic Salmon | Packaging around tray |
| Glazed | no | Other package info |
| Skin on/off | off | |
| Cooking method | | |
| Pot description | non stick pot | |
| Cover type | clear glass | |
| Heat setting | boil then turn off | |
| Water quantity | 8 cups | |
| Stove type | flat top | |
| Results: | | |
| Cook Method/instructions | bring water to boil, add fish, cover, turn off burner | |
| Start temp | −15 C. | |
| Cook time/temp | 145 F. @ 12 m 22 s | |
| | piece w/probe | piece 2 |
| Weight in (g) | 130.1 | 123.2 |
| Weight out (g) | 117.8 | 112.6 |
| Yield (%) | 90.55 | 91.40 |
| Thickness (mm) | 21.41 | 21.99 |
| Width (mm) | 90.2 | 97.5 |
| Length (mm) | 76.9 | 65.85 |
| Volume (mm3) | 148507.90 | 141184.05 |
| Observations | One corner floated. | |
| Exudate amount (visual) | a little on piece 1, almost nil on other | |
| Texture | typical mouth feel, nice fat | |
| Fat between flakes | yes | |
| Pictures | yes | |
| Logger | yes | |
| Next Steps | | |
| Test number | RW 674-D27 | |
| Date | 5/10/2016 | |
| Hours logged | JB-2 hrs Sherrie-2 hrs | |
| Purpose of this test | baseline testing, 22 mm, poly, 145 F., long narrow pieces | |
| Raw material | | Package |
| Code | Modified Chilean | Pouch in-house poly |
| Dimensions | 22 mm 4.5 oz | |
| Species | Atlantic Salmon | Packaging around tray |
| Glazed | no | Other package info |
| Skin on/off | off | |
| Cooking method | | |
| Pot description | non stick pot | |
| Cover type | clear glass | |
| Heat setting | boil then turn off | |
| Water quantity | 8 cups | |
| Stove type | flat top | |
| Results: | | |
| Cook Method/instructions | bring water to boil, add fish, cover, turn off burner | |
| Start temp | −15 C. | |
| Cook time/temp | 145 F. @ 14 m 32 s | |
| | piece w/probe | piece 2 |
| Weight in (g) | 136 | 120.7 |
| Weight out (g) | 124.7 | 105.1 |
| Yield (%) | 91.69 | 87.08 |
| Thickness (mm) | 21.67 | 21.24 |
| Width (mm) | 51.12 | 49.9 |
| Length (mm) | 147.8 | 131.9 |
| Volume (mm3) | 163728.47 | 139797.64 |
| Observations | One corner floated. Piece 2 had some gapping. | |
| Exudate amount (visual) | some on one piece, almost none on other. | |
| Texture | typical mouth feet, nice fat | |
| Fat between flakes | yes | |
| Pictures | yes | |
| Logger | yes | |
| Next Steps | | |
| Test number | RW 674-D-26 | |
| Date | May 6, 2016 | |
| Hours logged | 1 | |
| Purpose of this test | Compare (w/ D-25) 22 mm thick - in poly vs direct | |
| | to water (in cheesecloth - steep) | |
| Raw material | | Package |
| Code | Modified Chilean | Pouch cheese cloth |
| Dimensions | 22 mm thick | 4.5 oz |
| Specie | Atlantic Salmon | Packaging around tray |
| Glazed | no | Other package info |
| Skin on/off | off | |
| Cooking method | | |
| Pot description | non stick pot | |
| Cover type | modified clear glass | |
| Heat setting | Boil then turn off | |
| Water quantity | 8 cups | |
| Stove type | flat top | |
| Results: | | |
| Cook Method/instructions | bring water to boil, add fish, cover, turn off burner | |
| Start temp | −15 C. | |
| Cook time/temp | 145 F. @14 min | |
| | piece w/probe | piece 2 |
| Weight in | 131.1 | 135.6 |
| Weight out | 117.1 | 121.3 |
| Yield | 89.32 | 89.45 |
| Thickness mm | 22.12 | 21.85 |
| Width | 65.33 | 79.52 |
| Length | 112.09 | 92.65 |
| Observations | | |
| Observations | | |
| Exudate amount (visual) | none | |
| Texture | | |
| Fat between flakes | minimal, less than the comparison fish | |
| Pictures | yes | |
| Logger | Yes (no water reading, 2nd probe in other fish) | |
| Next Steps | | |
| Test number | RW 674-D-25 | |
| Date | May 6, 2016 | |
| Hours logged | 2 | |
| Purpose of this test | Compare (w/ D-26) 22 mm thick - in poly vs direct to | |
| | water (in cheesecloth - steep) | |
| Raw material | | Package |
| Code | Modified Chilean | Pouch in house poly |
| Dimensions | 22 mm thick | 4.5 oz |
| Specie | Atlantic Salmon | Packaging around tray |
| Glazed | no | Other package info |
| Skin on/off | off | |
| Cooking method | | |
| Pot description | non stick pot | |
| Cover type | modified clear glass | |
| Heat setting | Boil then turn off | |
| Water quantity | 8 cups | |
| Stove type | flat top | |
| Results: | | |
| Cook Method/instructions | bring water to boil, add fish, cover, turn off burner | |
| Start temp | −15 C. | |
| Cook time/temp | 145 F. @ approx 14 min - PROBE FAIL - fish taken out of pot | |
| | when other was cooked | |
| | piece w/probe | piece 2 |
| Weight in | 136.0 | 134.4 |
| Weight out | 119.2 | 119.8 |
| Yield | 87.65 | 89.14 |
| Thickness mm | 21.71 | 21.57 |
| Width | 67.22 | 64.76 |
| Length | 117.37 | 116.05 |
| Observations | Temperature climbed too quickly, determined after test | |
| | that probe has a short | |
| Observations | | |
| Exudate amount (visual) | minimal | |
| Texture | | |
| Fat between flakes | More than the comparison D-26 in water) | |
| Pictures | yes | |
| Logger | No | |
| Next Steps | | |
| Test number | RW 674-D-24 | |
| Date | May 3, 2016 | |
| Hours logged | 1 | |
| Purpose of this test | Retest - D-1 with no “plastic” | |
| Raw material | | Package |
| Code | Modified Chilean | Pouch cheesecloth |
| Dimensions | | |
| Specie | Atlantic Salmon | Packaging around tray |
| Glazed | no | Other package info |
| Skin on/off | off | |

| Cooking method | | | |
|---|---|---|---|
| Pot description | non stick pot | | |
| Cover type | modified clear glass | | |
| Heat setting | High | | |
| Water quantity | 8 cups | | |
| Stove type | flat top | | |
| Results: | | | |
| Cook Method/instructions | bring water to boil, add fish, cover, turn off burner | | |
| Start temp | −15 C. | | |
| Cook time/temp | 158 F. @ 18 min 43 sec | | |
| | piece w/probe | piece 2 | 16 min 145.9 |
| Weight in | 132.6 | 127.2 | 17 min 150.9 |
| Weight out | 116.6 | 107.7 | 18 min 155.3 |
| Yield | 87.93 | 84.67 | |
| Thickness mm | 22.77 | 21.5 | |
| Width | 73.58 | 53.22 | |
| Length | 83.9 | 130.66 | |

| Observations | This test had the most noticible difference between the two piece of | |
|---|---|---|
| | fish - just chance or does the water exposure amplify differences? | |
| Observations | Probe piece dense and dry and chewy, other pc flaky moist | |
| Exudate amount (visual) | almost nil | |
| Texture | some slime, slightly more chewy than in pouch, wet bite | |
| Fat between flakes | Yes - more in 1 piece | |
| Pictures | yes | |
| Logger | yes | |
| Next Steps | | |
| Test number | RW 674-D-23 | |
| Date | May 3, 2016 | |
| Hours logged | 1 | |
| Purpose of this test | Retest - D-1 with no “plastic” | |
| | ** Error - heat not turned off for 2 min*** | |
| Raw material | | Package |
| Code | Modified Chilean | Pouch cheesecloth |
| Dimensions | | |
| Specie | Atlantic Salmon | Packaging around tray |
| Glazed | no | Other package info |
| Skin on/off | off | |
| Cooking method | | |
| Pot description | non stick pot | |
| Cover type | modified clear glass | |
| Heat setting | High | |
| Water quantity | 8 cups | |
| Stove type | flat top | |
| Results: | | |
| Cook Method/instructions | bring water to boil, add fish, cover, turn off burner *****error - pot | |
| | not trned off for 2 min** | |
| Start temp | −15 C. | |
| Cook time/temp | 158 F. @ 12 min 53 sec | |
| | piece w/probe | piece 2 |
| Weight in | 138.9 | 120.5 |
| Weight out | 122.3 | 104.6 |
| Yield | 88.05 | 86.80 |
| Thickness mm | 21.65 | 22.16 |
| Width | 80.65 | 47.26 |
| Length | 97.17 | 146.49 |
| Observations | delicate at ends | |
| | slime not as noticable as D-21 | |
| | when probe pc squeezed - fat rose to surface after cooking | |
| Observations | | |
| Exudate amount (visual) | almost nil | |
| Texture | slightly more chewy than in pouch, wet bite | |
| Fat between flakes | Yes - more in probe piece | |
| Pictures | yes | |
| Logger | yes | |
| Next Steps | Need to retest this correctly | |
| Test number | RW 674-D-22 | |
| Date | May 3, 2016 | |
| Hours logged | 1 | |
| Purpose of this test | Test 2 × 4.5 oz - 22 mm - in poly pouch as comparison to D-21 | |
| Raw material | | Package |
| Code | Modified Chilean 4.5 oz | Pouch in house poly |
| Dimensions | 22 mm | |
| Specie | Atlantic Salmon | Packaging around tray |
| Glazed | no | Other package info |
| Skin on/off | off | |

| Cooking method | | | |
|---|---|---|---|
| Pot description | non stick pot | | |
| Cover type | modified clear glass | | |
| Heat setting | High | | |
| Water quantity | 8 cups | | |
| Stove type | flat top | | |
| Results: | | | |
| Cook Method/instructions | bring water to boil, add pouches of fish, cover, turn off burner | | |
| Start temp | −15 C. | | |
| Cook time/temp | 158 F. @ 21 min 06 sec | | |
| | piece w/probe | piece 2 | 14 min 130.1 |
| Weight in | 140.9 | 133.1 | 15 min 136.9 |
| Weight out | 126.0 | 121.5 | 16 min 142.3 |
| Yield | 89.43 | 91.28 | 17 min 147.0 |
| | | | 18 min 150.8 |
| Thickness mm | 22.3 | 22.2 | 19 min 153.3 |
| Width | 71.00 | 48.25 | 20 min 155.6 |
| Length | 97.73 | 144.35 | |

| Observations | 1 corner floating | |
|---|---|---|
| | 1 pc greyer and less attrctive - it is best taste and texture | |
| Observations | | |
| Exudate amount (visual) | minimal | |
| Texture | pc with probe is chewier and drier than other pc | |
| Fat between flakes | yes | |
| Pictures | yes | |
| Logger | yes | |
| Next Steps | Continue 22 mm testing | |
| Test number | RW 674-D-21 | |
| Date | May 3, 2016 | |
| Hours logged | 2 | |
| Purpose of this test | Test 2 × 4.5 oz - 22 mm thick pieces without pouch (use | |
| | cheesecloth “steep”), 4.5 oz Boil water, add fish, cover, turn off burner | |
| Raw material | | Package |
| Code | Modified Chilean | Pouch cheesecloth |
| Dimensions | | |
| Specie | Atlantic Salmon | Packaging around tray |
| Glazed | no | Other package info |
| Skin on/off | off | |

| Cooking method | | | |
|---|---|---|---|
| Pot description | non stick pot | | |
| Cover type | modified clear glass | | |
| Heat setting | High | | |
| Water quantity | 8 cups | | |
| Stove type | flat top | | |
| Results: | | | |
| Cook Method/instructions | bring water to boil, add fish, cover, turn off burner | | |
| Start temp | −15 C. | | |
| Cook time/temp | 158 F. @ 22 min 27 sec | | |
| | piece w/probe | piece 2 | 125 @ 12 min |
| Weight in | 129.5 | 126.6 | 142 @ 15 min |
| Weight out | 112.2 | 108.5 | 144.5 @ 16 min |
| Yield | 86.64 | 85.70 | 148 @ 17 min |
| | | | 150 @ 18 min |
| Thickness mm | 22.02 | 22.60 | 152.9 @ 19 min |
| Width | 48 | 38 | 154.7 @ 20 min |
| Length | 115.7 | 153 | 156 @ 21 min |

| Observations | Wondering if water/fat which would have been enclosed in pouch | |
|---|---|---|
| | during previous testing acted ad insulator/heat transfer? | |
| | Very delicate at this ends | |
| | Slimy texture between some flakes | |
| Observations | | |
| Exudate amount (visual) | Very minimal | |
| Texture | slightly watery bite, most is typical chew with some areas more chewy | |
| | slimy between some flakes | |
| Fat between flakes | Yes | |
| Pictures | yes | |
| Logger | yes | |
| Next Steps | Need to retest this (D-23 & 24) aditionally test 22 mm in poly | |
| | for comparison (D-22) | |
| Test number | RW 674-D-20 | |
| Date | Apr. 21, 2016 | |
| Hours logged | 1 | |
| Purpose of this test | Re-test of D-19 | |
| | Test Mylar pouch from Multivac | |
| | **note that fishh arrived slightly thawed from Multivac** | |
| Raw material | | Package |
| Code | Modified Chilean 4.5 oz | Pouch Mylar/Multivac |
| Dimensions | | |
| Specie | Atlantic Salmon | Packaging around tray |
| Glazed | no | Other package info |
| Skin on/off | off | |

| Cooking method | | | |
|---|---|---|---|
| Pot description | non stick pot | | |
| Cover type | modified clear glass | | |
| Heat setting | High | | |
| Water quantity | 8 cups | | |
| Stove type | flat top | | |
| Results: | | | |
| Cook Method/instructions | bring water to boil, add pouches of fish, cover, turn off burner | | |
| Start temp | −15 C. | | |
| Cook time/temp | 158 F. @ 21 min | | |
| | piece w/probe | piece 2 | 140 @ 16:40 |
| Weight in | 133 | 132.1 | |
| Weight out | 122.9 | 121.8 | 143 @ 17:10 |
| Yield | 92.41 | 92.20 | |
| | | | 145 @ 17:30 |
| Thickness mm | 24.75 w/mylar | 0 | |
| Width | 0 | 0 | |

| Observations | Same as D-19 | |
|---|---|---|
| Observations | | |
| Exudate amount (visual) | Not much | |
| Texture | slight tough, could be due to thaw cycle, nice flake | |
| Fat between flakes | some | |
| Pictures | yes | |
| Logger | | |
| Next Steps | verify this test | |
| Test number | RW 674-D-19 | |
| Date | Apr. 21, 2016 | |
| Hours logged | 2 | |
| Purpose of this test | Test Mylar pouch from Multivac | |
| | **note that fishh arrived slightly thawed from Multivac** | |
| Raw material | | Package |
| Code | Modified Chilean 4.5 oz | Pouch Mylar/Multivac |
| Dimensions | | |
| Specie | Atlantic Salmon | Packaging around tray |
| Glazed | no | Other package info |
| Skin on/off | off | |

| Cooking method | | | |
|---|---|---|---|
| Pot description | non stick pot | | |
| Cover type | modified clear glass | | |
| Heat setting | High | | |
| Water quantity | 8 cups | | |
| Stove type | flat top | | |
| Results: | | | |
| Cook Method/instructions | bring water to boil, add pouches of fish, cover, turn off burner | | |
| Start temp | −15 C. | | |
| Cook time/temp | 158 F. @ 25 min 40 sec | | |
| | piece w/probe | piece 2 | 140 @ 20:30 |
| Weight in | 0 | 0 | |
| Weight out | 0 | 0 | 143 @ 21:20 |
| Yield | #DIV/0! | #DIV/0! | |
| | | | 145 @ 21:50 |
| Thickness mm | 24.75 w/mylar | 0 | |
| Width | 0 | 0 | |

| Observations | Mylar held together |
|---|---|
| | Need to check mylar measurement and subtract |
| Observations | |
| Exudate amount (visual) | Not much |
| Texture | slight tough, could be due to thaw cycle |
| Fat between flakes | |
| Pictures | yes |
| Logger | |
| Next Steps | verify this test |

| Test number | RW 674-D-18 | |
|---|---|---|
| Date | Apr. 14, 2016 | |
| Hours logged | 2 | |
| Purpose of this test | Test 2 pouch with larger than 19-20 mm thick target, 4.5 oz - for baseline | |
| | Boil water, add pouches, cover, turn off burner | |
| Raw material | Modified Chilean | Package |
| Code | | Pouch in-house poly |
| Dimensions | | |
| Specie | Atlantic Salmon | Packaging around tray |
| Glazed | no | Other package info |
| Skin on/off | off | |
| Cooking method | | |
| Pot description | non stick pot | |
| Cover type | modified clear glass | |
| Heat setting | High | |
| Water quantity | 8 cups | |
| Stove type | flat top | |
| Results: | | |
| Cook Method/instructions | bring water to boil, add pouches of fish, cover, turn off burner | |
| Start temp | 4 F. | |
| Cook time/temp | 158 F. @ 11 min 54 sec | |
| | piece w/probe | piece 2 |
| Weight in | 119.2 | 129.2 |
| Weight out | 108.5 | 118.0 |
| Yield | 91.02 | 91.33 |
| Thickness mm | 21.48 | 24.85 |
| Width | 50.91 | 51.55 |
| Observations | Slightly nested at the first, floated apart while cooking | |
| Observations | | |
| Exudate amount (visual) | mild | |
| Texture | typical for D series/Atl. Salmon - good chew, moist | |
| Fat between flakes | yes | |
| Pictures | yes | |
| Logger | yes | |
| Next Steps | Continue to test different thickness of fish. (4.5 oz) | |
| Test number | RW 674-D-17 | |
| Date | Apr. 13, 2016 | |
| Hours logged | 1 | |
| Purpose of this test | Test 2 pouch with larger than 19-20 mm thick target, 4.5 oz - for baseline | |
| | Boil water, add pouches, cover, turn off burner | |
| | ***error, boiled for 4 min** | |
| Raw material | Modified Chilean | Package |
| Code | | Pouch in-house poly |
| Dimensions | | |
| Specie | Atlantic Salmon | Packaging around tray |
| Glazed | no | Other package info |
| Skin on/off | off | |
| Cooking method | | |
| Pot description | non stick pot | |
| Cover type | modified clear glass | |
| Heat setting | High | |
| Water quantity | 8 cups | |
| Stove type | flat top | |
| Results: | | |
| Cook Method/instructions | ** ERROR boiled 4 min**bring water to boil, add pouches of fish, | |
| | cover, turn off burner | |
| Start temp | 4 F. | |
| Cook time/temp | 158 F. @ 12 min 45 sec | |
| | piece w/probe | piece 2 |
| Weight in | 130.7 | 131.5 |
| Weight out | 116.1 | 117.9 |
| Yield | 88.83 | 89.66 |
| Thickness mm | 23.69 | 26.89 |
| Width | 80.9 | 54.11 |
| Observations | Error - did not turn off pot for 4 min | |
| Observations | | |
| Exudate amount (visual) | moderate one pc on one side, rest mild | |
| Texture | typical for D series/Atl. Salmon | |
| Fat between flakes | yes | |
| Pictures | yes | |
| Logger | yes | |
| Next Steps | Continue to test different thickness of fish. (4.5 oz) | |
| Test number | RW 674-D-16 | |
| Date | Apr. 13, 2016 | |
| Hours logged | 1 | |
| Purpose of this test | Test 2 pouch with larger than 19-20 mm thick target, 4.5 oz - for baseline | |
| | Boil water, add pouches, cover, turn off burner | |
| Raw material | Modified Chilean | Package |
| Code | | Pouch in-house poly |
| Dimensions | | |
| Specie | Atlantic Salmon | Packaging around tray |
| Glazed | no | Other package info |
| Skin on/off | off | |
| Cooking method | | |
| Pot description | non stick pot | |
| Cover type | modified clear glass | |
| Heat setting | High | |
| Water quantity | 8 cups | |
| Stove type | flat top | |
| Results: | | |
| Cook Method/instructions | bring water to boil, add pouches of fish, cover, turn off burner | |
| Start temp | 4 F. | |
| Cook time/temp | 158 F. @ 16 min 15 sec | |
| | piece w/probe | piece 2 |
| Weight in | 129.4 | 124.7 |
| Weight out | 114.9 | 109.9 |
| Yield | 88.79 | 88.13 |
| Thickness mm | 25.75 | 28.49 |
| Width | 45.14 | 55.2 |
| Observations | Nothing unusual | |
| Observations | | |
| Exudate amount (visual) | very mild | |
| Texture | typical for D series/Atl. Salmon | |
| Fat between flakes | visible in some places, not in others. More visible in probe piece | |
| Pictures | yes | |
| Logger | yes | |
| Next Steps | Continue to test different thickness of fish. (4.5 oz) | |
| Test number | RW 674-D-15 | |
| Date | Apr. 13, 2016 | |
| Hours logged | 2 | |
| Purpose of this test | Test BEVEL cut | |
| | Boil water, add pouches, cover, turn off burner | |
| Raw material | Hand cut | Package |
| Code | Sobeys | Pouch in-house poly |
| Dimensions | | |
| Specie | Atlantic Salmon | Packaging around tray |
| Glazed | no | Other package info |
| Skin on/off | off | |
| Cooking method | | |
| Pot description | non stick pot | |
| Cover type | modified clear glass | |
| Heat setting | High | |
| Water quantity | 8 cups | |
| Stove type | flat top | |
| Results: | | |
| Cook Method/instructions | bring water to boil, add pouches of fish, cover, turn off burner | |
| Start temp | 4 F. | |
| Cook time/temp | 158 F. @ 12 min | |
| | piece w/probe | filler piece |
| Weight in | 120.7 | 111.1 |
| Weight out | 106.9 | 98.0 |
| Yield | 88.57 | 88.21 |
| Thickness mm | 20.03 | 14.89 |
| Width | 69.55 | 77.38 |
| Observations | Thermometer partially broke out of portion, not the point but instead | |
| | rotated out of edge | |
| Observations | | |
| Exudate amount (visual) | excess on top of one, moderate top of other. Minor on bottom | |
| | and sides, exudate | |
| Texture | too soft, mush between flakes - exudate | |
| Fat between flakes | none visible, minor feel of it in mouth | |
| Pictures | yes | |
| Logger | yes | |
| Next Steps | Test Bevel cut with supplier cut portions - is the fish the problem or | |
| | due to cutting through the flakes? | |
| Test number | RW 674-D-14 | |
| Date | Apr. 6, 2016 | |
| Hours logged | 2 | |
| Purpose of this test | Test 2 pouch with larger than 19-20 mm thick target, 4.5 oz - for baseline | |
| | Boil water, add pouches, cover, when pot is back to boil - turn off burner | |
| Raw material | Modified Chilean | Package |
| Code | | Pouch in-house poly |
| Dimensions | | |
| Specie | Atlantic Salmon | Packaging around tray |
| Glazed | no | Other package info |
| Skin on/off | off | |
| Cooking method | | |
| Pot description | non stick pot | |
| Cover type | modified clear glass | |
| Heat setting | High | |
| Water quantity | 8 cups | |
| Stove type | flat top | |
| Results: | | |
| Cook Method/instructions | bring water to boil, add pouches of fish, cover, bring water back | |
| | to boil, turn off burner | |
| Start temp | 19.2 F. | |
| Cook time/temp | 158 F. @ 18 min 46 sec | |
| | piece w/probe | filler piece |
| Weight in | 133.4 | 124.5 |
| Weight out | 112.1 | 110.0 |
| Yield | 84.03 | 88.35 |
| Thickness mm | 26.48 | 26.72 |
| Observations | 1 pc floated on one corner - this corner visually cooked slower, but | |
| | was fully cooked when center was 158 | |
| | seemed to be more fat purge in this test - pc with no probe | |
| | pc with probe had the dry area, pc no probe had more purge | |
| Observations | unsure if the dry area is the the same corner that floated | |
| Exudate amount (visual) | minor, all over complete surfaces - except corner that floated, this | |
| | area has more | |
| Texture | typical firmness, moist | |
| Fat between flakes | yes - except one small center area of one piece very little fat - is | |
| | this the fat that | |
| Pictures | yes | |
| Logger | yes | |
| Next Steps | Continue to test different thickness of fish. | |
| Test number | RW 674-D-13 | |
| Date | Apr. 4, 2016 | |
| Hours logged | 4 | |
| Purpose of this test | Test oven bags - poly inner with paper overlay on ¾ of outside | |
| Raw material | Modified Chilean | Package |
| Code | | Pouch oven bags - Ig & sm/ |
| | | poly w/paper outer |
| Dimensions | | |
| Specie | Atlantic Salmon | Packaging around tray |
| Glazed | no | Other package info |
| Skin on/off | off | |

| Cooking method | | | |
|---|---|---|---|
| Pot description | non stick pot | | |
| Cover type | modified clear glass | | |
| Heat setting | Boil, then turn off | | |
| Water quantity | 8 cups | | |
| Stove type | flat top | | |
| Results: | | | |
| Cook Method/instructions | bring water to boil, add pouches | | |
| | of fish, cover, bring water back to boil, turn off burner | | |
| Start temp | | | |
| Cook time/temp | fail - 16 min not cooked due to floating - still 129.5 F. | | |
| | piece w/probe | filler piece | pc 2 in poly bag |
| Weight in | 125.2 | 124.7 | |
| Weight out | 0 | 0 | |
| Yield | 0.00 | 0.00 | |
| Thickness mm | 19.74 | 22.53 | |

| Observations | Probe likely crooked at first as temp climbed too fast - adjustment made | |
|---|---|---|
| | Floating, fish almost half out of water - did not cook - test abandoned | |
| | Plastic seems brittle close to where heated. | |
| Observations | Air seems to be leaking near probe hole. (Which is opposite paper seam) | |
| | Smaller bags - unable to find a vacuum level that would remove enough | |
| | air, yet not blow up bag. | |
| | For all, can pull apart seams in places | |
| Exudate amount (visual) | | |
| Texture | | |
| Fat between flakes | | |
| Pictures | No | |
| Logger | No | |
| Next Steps | No further testing of oven bag unless | |
| Test number | RW 674-D-12 | |
| Date | Apr. 1, 2016 | |
| Hours logged | 1 | |
| Purpose of this test | Test 2 pouch with 19-20 mm thick target, 4.5 oz | |
| | Boil water, add pouches, cover, when pot is back to boil - turn off burner | |
| Raw material | Modified Chilean | Package |
| Code | | Pouch in-house poly |
| Dimensions | | |
| Specie | Atlantic Salmon | Packaging around tray |
| Glazed | no | Other package info |
| Skin on/off | off | |
| Cooking method | | |
| Pot description | non stick pot | |
| Cover type | modified clear glass | |
| Heat setting | High | |
| Water quantity | 8 cups | |
| Stove type | flat top | |
| Results: | | |
| Cook Method/instructions | bring water to boil, add pouches of fish, cover, bring water back | |
| | to boil, turn off burner | |
| Start temp | 19.4 F. | |
| Cook time/temp | 158 F. @ 12 min 10 sec | |
| | piece w/probe | filler piece |
| Weight in | 125.8 | 121.2 |
| Weight out | 109.4 | 105.2 |
| Yield | 86.96 | 86.80 |
| Thickness mm | 20.16 | 18.5 |
| Observations | Fish pouches did not nest together | |
| | Water back to boil @ 1 min. 53 sec. | |
| | Continued to boil (bubbles break surface) for 5 min | |
| Observations | | |
| Exudate amount (visual) | minor, all over complete surfaces | |
| Texture | typical firmness, moist | |
| Fat between flakes | yes | |
| Pictures | yes | |
| Logger | yes | |
| Next Steps | Test different thickness of fish. Without bringing back to boil | |
| Test number | RW 674-D-11 | |
| Date | Apr. 1, 2016 | |
| Hours logged | 1 | |
| Purpose of this test | Verify D-9 | |
| Raw material | Modified Chilean | Package |
| Code | | Pouch in-house poly |
| Dimensions | | |
| Specie | Atlantic Salmon | Packaging around tray |
| Glazed | no | Other package info |
| Skin on/off | off | |
| Cooking method | | |
| Pot description | non stick pot | |
| Cover type | modified clear glass | |
| Heat setting | High | |
| Water quantity | 8 cups | |
| Stove type | flat top | |
| Results: | | |
| Cook Method/instructions | bring water to boil, add pouches of fish, cover, turn off burner | |
| Start temp | 18.6 F. | |
| Cook time/temp | 158 F. @ 13 min 11 sec | |
| | piece w/probe | filler piece |
| Weight in | 126.3 | 127.5 |
| Weight out | 111.6 | 116.4 |
| Yield | 88.36 | 91.29 |
| Thickness mm | 18.26 | 21.3 |
| Observations | Appears that top edge may not be completely submerged (difficult to | |
| | determine during first steam/condensation on lid) when cleared, it was a | |
| | very small edge out of water | |
| Observations | More steam loss than usual as weather strip started to let go when | |
| | positioning lid | |
| Exudate amount (visual) | minor, all over complete surfaces - similar to D-9 | |
| Texture | typical firmness, good similar to D-9 | |
| Fat between flakes | yes similar to D-9 | |
| Pictures | yes | |
| Logger | yes | |
| Next Steps | Test bringing back to boil then turn off heat (time boil) | |
| Test number | RW 674-D-10 | |
| Date | Apr. 1, 2016 | |
| Hours logged | 1 | |
| Purpose of this test | Not intended test due to error in not turning off burner | |
| | Test became boil for 2 min then turn off heat, was back at hard boil | |
| Raw material | Modified Chilean | Package |
| Code | | Pouch in-house poly |
| Dimensions | | |
| Specie | Atlantic Salmon | Packaging around tray |
| Glazed | no | Other package info |
| Skin on/off | off | |
| Cooking method | | |
| Pot description | non stick pot | |
| Cover type | modified clear glass | |
| Heat setting | High | |
| Water quantity | 8 cups | |
| Stove type | flat top | |
| Results: | | |
| Cook Method/instructions | bring water to boil, add pouches of fish, cover, ** burner turned | |
| | off after 2 min. ** turn off burner | |
| Start temp | 21.9 F. | |
| Cook time/temp | 158 F. @ 9 min 24 sec | |
| | piece w/probe | filler piece |
| Weight in | 126.6 | 121.4 |
| Weight out | 111.5 | 109.0 |
| Yield | 88.07 | 89.79 |
| Thickness mm | 20.69 | 20.06 |
| Observations | Water probe - is ontop of a pouch due to alignment of access | |
| | ports/fish/fish probe - therefore it is possible that proper water | |
| | temperature is not being recorded | |
| | water at hard boil whene discovered at 2 min | |
| Exudate amount (visual) | minor, all over complete surfaces | |
| Texture | typical firmness, good | |
| Fat between flakes | yes | |
| Pictures | yes | |
| Logger | yes | |
| Next Steps | Due to error in this test, next step is to verify D-9 | |
| Test number | RW 674-D-9 | |
| Date | Apr. 1, 2016 | |
| Hours logged | 2 | |
| Purpose of this test | Test 2 pouch w/ 1 piece ea, 19-20 mm thickness target, 4.5 oz | |
| | monitor if amount of water needs to change to accomidate 2 | |
| | Add fish, cover and turn off heat | |
| Raw material | Modified Chilean | Package |
| Code | | Pouch in-house poly |
| Dimensions | | |
| Specie | Atlantic Salmon | Packaging around tray |
| Glazed | no | Other package info |
| Skin on/off | off | |
| Cooking method | | |
| Pot description | non stick pot | |
| Cover type | modified clear glass | |
| Heat setting | High | |
| Water quantity | 8 cups - enough | |
| Stove type | flat top | |
| Results: | | |
| Cook Method/instructions | bring water to boil, add pouches of fish, cover, turn off burner | |
| Start temp | 19.9 F. | |
| Cook time/temp | 158 F. @ 9 min 59 sec | |
| | piece w/probe | filler piece |
| Weight in | 126.0 | 124.7 |
| Weight out | 109.7 | 111.4 |
| Yield | 87.06 | 89.33 |
| Thickness mm | 19.24 | 19.37 |
| Observations | Fish pouches did not nest together | |
| | Water probe was not likely properly submerged at first, adjusted after | |
| | lid cleared | |
| Exudate amount (visual) | minor, all over complete surfaces | |
| Texture | moist, great mouthfeel (fat) | |
| Fat between flakes | yes | |
| Pictures | yes | |
| Logger | yes | |
| Next Steps | Verify this test | |
| Test number | RW 674-D-8 | |
| Date | Mar. 31, 2016 | |
| Hours logged | 2 | |
| Purpose of this test | Test 2 pieces, 19-20 mm thickness target | |
| | test if amount of water needs to change | |
| | ** error in test - forgot to turn off pot for 5 min, 20 sec | |
| Raw material | Modified Chilean | Package |
| Code | | Pouch in-house poly |
| Dimensions | | |
| Specie | Atlantic Salmon | Packaging around tray |
| Glazed | no | Other package info |
| Skin on/off | off | |
| Cooking method | | |
| Pot description | non stick pot | |
| Cover type | modified clear glass | |
| Heat setting | High | |
| Water quantity | 8 cups | |
| Stove type | flat top | |
| Results: | | |
| Cook Method/instructions | bring water to boil, add pouches of fish, cover, turn off burner ** this | |
| | test pot on for 5 min. 20 sec. | |
| Start temp | 19 F. | |
| Cook time/temp | 158 F. @ 13 min 6 sec | |
| | piece w/probe | filler piece |
| Weight in | 118.9 | 112.3 |
| Weight out | 101.9 | 100.9 |
| Yield | 85.70 | 89.85 |
| Thickness mm | 20.72 | 21.91 |
| Observations | fish did not seem to sit tightly together (this was a concern) | |
| | piece with probe broke from rough handling while removing from pouch | |
| Exudate amount (visual) | very little, all over complete surfaces | |
| Texture | moist, nice fat | |
| Fat between flakes | yes, visible and in mouth feel | |
| Pictures | yes | |
| Logger | yes | |
| Next Steps | test 2 × 4.5 oz, 19-20 mm traget, turn water off when fish added to pot | |
| Test number | RW 674-D-7 | |
| Date | Mar. 11, 2016 | |
| Hours logged | 1 | |
| Purpose of this test | Data collection reverse sous vide - cooking until fish is 158 F., thin | |
| | tail, targeting 15 min | |
| Raw material | | Package |
| Code | 1050100 | Pouch in-house poly |
| Dimensions | 19 mm | |
| Specie | Atlantic Salmon | Packaging around tray |
| Glazed | no | Other package info |
| Skin on/off | off | |
| Cooking method | | |
| Pot description | non stick pot | |
| Cover type | modified clear glass | |
| Heat setting | High | |
| Water quantity | 8 cups | |
| Stove type | flat top | |
| Results: | | |
| Cook Method/instructions | bring water to boil, add pouch of fish, cover, turn off burner | |
| Start temp | −13 C. | |
| Cook time/temp | 158 F. @ 10 min. - caution that due to thinness thermometer may | |
| | be off center | |
| | fish | liquid |
| Weight in | 166.0 | |
| Weight out | 147.8 | 16.4 |
| Yield | 89.04 | |
| Thickness | 19 mm | |
| Observations | full set up does not fit into pot due to size of fish - did this cause | |
| | pressure on thermometer to push too close to surface? There does not | |
| | seem to be evidence of this in the cooked piece. | |
| Exudate amount (visual) | very little | |
| Texture | dry | |
| Fat between flakes | minimal | |
| Pictures | yes | |
| Logger | yes | |
| Next Steps | continue thin tail to verify | |
| Test number | RW 674-D-6 | |
| Date | Mar. 11, 2016 | |
| Hours logged | 1 | |
| Purpose of this test | Data collection reverse sous vide - cooking until fish is 158 F. | |
| Raw material | | Package |
| Code | 1050100 | Pouch in-house poly |
| Dimensions | 27 mm | |
| Specie | Atlantic Salmon | Packaging around tray |
| Glazed | no | Other package info |
| Skin on/off | off | |
| Cooking method | | |
| Pot description | non stick pot | |
| Cover type | modified clear glass | |
| Heat setting | High | |
| Water quantity | 8 cups | |
| Stove type | flat top | |
| Results: | | |
| Cook Method/instructions | bring water to boil, add pouch of fish, cover, turn off burner | |
| Start temp | −13 C. | |
| Cook time/temp | 158 F. @ 22 min. 27 sec | |
| | fish | liquid |
| Weight in | 167.0 | |
| Weight out | 143.9 | 21.3 |
| Yield | 86.17 | |
| Thickness | 27 mm | |
| Observations | Not much fat in liquid | |
| Exudate amount (visual) | some mostly on edge | |
| Texture | dry | |
| Fat between flakes | yes, not as much as some previous, visible | |
| Pictures | yes | |
| Logger | yes | |
| Next Steps | try thinner piece - tail | |
| Test number | RW 674-D-5 | |
| Date | Mar. 9, 2016 | |
| Hours logged | 2 | |
| Purpose of this test | Data collection reverse sous vide - cooking until fish falls to danger zone | |
| Raw material | | Package |
| Code | 1050100 | Pouch in-house poly |
| Dimensions | 29.5 mm | |
| Specie | Atlantic Salmon | Packaging around tray |
| Glazed | no | Other package info |
| Skin on/off | off | |
| Cooking method | | |
| Pot description | non stick pot | |
| Cover type | modified clear glass | |
| Heat setting | High | |
| Water quantity | 8 cups | |
| Stove type | flat top | |
| Results: | | |
| Cook Method/instructions | bring water to boil, add pouch of fish, cover, turn off burner | |
| Start temp | −13 C. | |
| Cook time/temp | 158 F. @ 22 min 140 F. @ 1 hour 39 min | |
| | fish | liquid |
| Weight in | 181.7 | |
| Weight out | 150.7 | 27.7 |
| Yield | 82.94 | |
| Thickness | 29.5 | |
| Observations | Floated slightly | |
| Exudate amount (visual) | some on fat line side | |
| Texture | moist center to dry tips | |
| Fat between flakes | | |
| Pictures | yes | |
| Logger | yes | |
| Next Steps | pull out fish at earlier stage (not after cool) 158 F., 170 F., 15 min | |
| Test number | RW 674-D-4 | |
| Date | Mar. 8, 2016 | |
| Hours logged | 2 | |
| Purpose of this test | Data collection reverse sous vide - cooking until fish falls to danger zone | |
| Raw material | | Package |
| Code | 1050100 | Pouch in-house poly |
| Dimensions | 30.25 mm | |
| Specie | Atlantic Salmon | Packaging around tray |
| Glazed | no | Other package info |
| Skin on/off | off | |
| Cooking method | | |
| Pot description | stainless steel | |
| Cover type | modified clear glass | |
| Heat setting | High | |
| Water quantity | 8 cups | |
| Stove type | flat top | |
| Results: | | |
| Cook Method/instructions | bring water to boil, add pouch of fish, cover, turn off burner | |
| Start temp | −13 C. | |
| Cook time/temp | 158 F. @ 22 min 140 F. @ 2 hours | |
| | fish | liquid |
| Weight in | 179.4 | |
| Weight out | 149.3 | 28.4 |
| Yield | 83.22 | |
| Thickness | 30.25 | |

| Observations | Floated slightly, liquid very clear with minimal fat (less than previous) |
|---|---|
| Exudate amount (visual) | minimal |
| Texture | moist center to dry tips |
| Fat between flakes | |
| Pictures | yes |
| Logger | yes |
| Next Steps | |

[symbol]

indicates data missing or illegible when filed

Purpose of Test

Data collection reverse sous vide - cooking until fish falls to danger zone
Data collection reverse sous vide - cooking until fish is 158 F.
Data collection reverse sous vide - cooking until fish is 158 F., thin tail, targeting 15 min
Test 2 pieces, 19-20 mm thickness target; test if amount of water needs to change
Test 2 pouch w/ 1 piece ea, 19-20 mm thickness target, 4.5 oz
Verify D-9
Test 2 pouch with 19-20 mm thick target, 4.5 oz
Boil water, add pouches, cover, when pot is back to boil - turn off burner
Test oven bags - poly inner with paper overlay on ¾ of outside
Test 2 pouch with larger than 19-20 mm thick target, 4.5 oz - for baseline
Boil water, add pouches, cover, when pot is back to boil - turn off burner
Test BEVEL cut
Test 2 pouch with larger than 19-20 mm thick target, 4.5 oz - for baseline
Test Mylar pouch from Multivac
Retest D-19
Test 2 × 4.5 oz - 22 mm thick pieces without pouch (use cheesecloth “steep”), 4.5 oz
Test 2 × 4.5 oz - 22 mm - in poly pouch as comparison to D-21
Retest - D-1 with no “plastic”
Compare (w/ D-26) 22 mm thick - in poly
Compare (w/ D-25) 22 mm thick - direct to water (in cheesecloth - steep)
baseline testing, 22 mm, poly, 145 F., long narrow pieces
baseline testing, 22 mm, poly, 145 F., square pieces
baseline testing, 22 mm, poly, 145 F.
baseline testing, 22 mm, poly, 145, GLAZE
baseline testing, 22 mm, 145, CHEESECLOTH
baseline testing, 22 mm, 145, RETORT BAG
baseline testing, 22 mm, 145, only 1 piece of salmon to try to cook completely in retort
Test Bring back to boil after adding fish.
Test Bring back to boil after adding fish.
Test Bring back to hard rolling boil after adding fish.
Continue testing - Bring back to hard rolling boil after adding fish.
test temp. rise after fish removed from pot
test temp. rise after fish removed from pot rep 2
test temp. rise after fish removed from pot, take out at 135 F.
repeat D-48
remove fish at 138 F. and observe temperature
repeat D50 (remove at 138 F.)
scored fish baseline (17 mm, 2 sides, 2 directions, JB 19/5/2016)
repeat D52 - scored fish baseline (17 mm, 2 sides, 2 directions, JB 19/5/2016)
test glazed scored salmon (17 mm, 2 sides, 2 directions; Creamy Dill 30/5/2016)
repeat D54 w/ roasted garlic glaze
test glaze from June 1 - BBQ
test glaze from June 1 - Miso Citrus
test glaze from June 1 - Maple Mustard
test glaze from June 1 - Ginger Wasabi Soy
repeat D52 (scored fish baseline - 17 mm, 2 sides, 2 directions)
repeat D52
20 mm Maple Mustard, remove at 138
20 mm no sauce, remove at 138
sauce applied fresh, Maple Mustard, scored; 20 mm
20 mm unscored
test 20 mm Maple Mustard by adding fish then bringing to boil
Mesquite Rub (Griffiths HLF3591) 22 mm unscored, coated 13/6/2016
repeat D69
MM with added starch (22 mm, unscored, RW 679-4, dipped 10/6/2016)
MMS
compare MM7 with MM6
4 cups water - 1 piece
repeat D74
10 cups, 2 pieces, MM5
6 cups, 2 pieces, MM4
20 mm w/ sauce
repeat D78
repeat D78
repeat D78
6 cups water and 1 piece fish
8 cups water, 1 piece fish
10 cups water for 1 piece fish
repeat D69
Maille (compare to D87)
Fleur de Dijon (compare to D86)
test sauce placed in vacuum bag then fish then sealed
test meat tenderizer pushed all the way through fresh raw salmon
repeat D89
roasted garlic and herb: test if performs similar to MM
lime chili marinade (repeat D32 - 15% powder, 10% pickup)
Test 9 mm deep scores in reversa sous vide
cooking prep evaluation
thickness includes sauce and poly
In red indicates did not reach temperature of 145 F.

| Average | No Sauce | Sauce | Difference | |
|---|---|---|---|---|
| Unscored | 11.6 | 12.0 | 0.40 | |
| Scored | 12.2 | 13.0 | 0.79 | |
| | | | 0.60 | 35.78 |

seconds

| Standard Deviation | | |
|---|---|---|
| Unscored | 1.4 | 2.0 |
| Scored | 1.4 | 1.1 |

*Cooking times to 138 F. used.

| Average | 20 mm | 22 mm | # Tests 20 mm | # Tests 22 mm |
|---|---|---|---|---|
| Sauce. Score. | 12.30 | 12.96 | 2 | 8 |
| Sauce. No score. | 13.13 | 11.97 | 6 | 9 |
| No sauce. Score. | 10.17 | 12.17 | 2 | 6 |
| No sauce. No score. | 7.56 | 11.56 | 2 | 9 |

| Standard Deviation | 20 mm | 22 mm |
|---|---|---|
| Sauce. Score. | 0.71 | 1.11 |
| Sauce. No score. | 0.83 | 2.02 |
| No sauce. Score. | 0.24 | 1.43 |
| No sauce. No score. | 1.45 | 1.37 |

| | | |
|---|---|---|
| Types of cuts. | | |
| No Sauce. 22 mm. Cook to 138 F. | St. Dev. | # Tests |

| Type | Tests | Average | 1.43 | 6 |
|---|---|---|---|---|
| Scored | D52-3, D62-3 | 12.17 | 1.52 | 4 |
| Tenderized | D89-90 | 11.33 | | |

| Coatings, 22 mm. No score. Cook to 138 F. | | | Standard Deviati [symbol] | # Tests |
|---|---|---|---|---|
| Type | Tests | Average | 0.77 | 6 |
| Mesquite Marinade Rub | D69-1,2, D70-1,2, D85-1,2 | 12.62 | 1.82 | 4 |
| Mustard Maple Sauce | D71-1,2, D72-1,2 | 13.43 | 0.42 | 5 |
| Lime Chili Glaze First Time | D32-36 | 10.35 | 2.12 | 5 |
| Lime Chili Glaze Second Time | D96-100 | 12.20 | 2.78 | 10 |
| Roasted Garlic & Herb Existing Pr [symbol] | D91-95 | 11.99 | 1.37 | 9 |

[symbol]

indicates data missing or illegible when filed

| Maple Mustard | | | | |
|---|---|---|---|---|
| Sauce. No score. 22 mm. Cook to 138 F. | | | Cook | |
| Amount | | | Time to 138 [symbol] | Test # |
| of Water (cups) | # Pieces | Cups Water/Piece | 11.48 | D74 |
| 4 | 1 | 4 | 12.12 | D75 |
| 4 | 1 | 4 | 11.03 | D76-1 |
| 10 | 2 | 5 | 11.65 | D76-2 |
| 10 | 2 | 5 | 12.40 | D77-1 |
| 6 | 2 | 3 | 14.62 | D77-2 |
| 6 | 2 | 3 | 15.33 | D82 |
| 6 | 1 | 6 | 12.92 | D83 |
| 8 | 1 | 8 | 12.15 | D84 |
| | | | 15.98 | D71-1 |
| 8 | 2 | 4 | 13.4 | D71-2 |
| 8 | 2 | 4 | 11.84 | D72-1 |
| 8 | 2 | 4 | 12.48 | D72-2 |
| 8 | 2 | 4 | | |

[symbol]

indicates data missing or illegible when filed

1. A method of cooking fish comprising the following steps:
(i) Providing a frozen fillet of fish in a vacuum sealed bag suitable for cooking in boiling water;
(ii) Boiling water in a container by applying sufficient heat or energy source;
(iii) Placing the bag in the boiling water, and simultaneously or immediately thereafter remove the heat or energy source;
(iv) Retaining the bag in the water for a period of time to allow the fillet of fish to cook;
(v) Removing the bag from the water;
(vi) Delaying removal of the fillet of fish from the bag for an additional period of time; and
(vii) Removing the fillet of fish from the bag for consumption.

2. The method of claim 1 wherein the container is covered after placing the bag in the water.

3. The method of claim 1 wherein the fish is salmon.

4. The method of claim 1 wherein the fillet of fish is frozen within a range of −18 degrees to −15 degrees Celsius.

5. The method of claim 1 wherein the fillet of fish weighs between approximately 129 g and 155 g.

6. The method of claim 5 wherein the fillet of fish weighs 142 g.

7. The method of claim 6 wherein the fillet of fish has a thickness measured from top to bottom of between 2-3 cm.

8. The method of claim 1 wherein the bag is retained in the water for between 8 to 12 minutes.

9. The method of claim 8 wherein the bag is retained in the water for 10 minutes.

10. The method of claim 8 including delaying between 1 and 3 minutes between removing the bag from the water and removing the fillet of fish from the bag.

11. The method of claim 1 wherein the container contains 8 cups of the water.

12. The method of claim 1 wherein the fish or the fillet of fish is treated with moisture enhancing ingredients prior to the freezing.

13. A kit comprising a frozen fillet of fish in a vacuum sealable bag suitable for cooking in boiling water, and instructions to follow the method steps (ii) to (vii) of claim 1.

14. The kit of claim 13 including at least one of the following:
the instructions include a step of covering the container after placing the bag in the water;
the fish is salmon;
the fillet of fish is frozen within a range of −18 degrees to −15 degrees Celsius;
the fillet of fish weighs between approximately 129 g and 155 g;
the fillet of fish weighs 142 g;
the fillet of fish has a thickness measured from top to bottom of between 2-3 cm;
the instructions include a step of retaining the bag in the water for between 8 to 12 minutes;
the instructions include a step of retaining the bag in the water for 10 minutes;
the instructions include a step of delaying between 1 and 3 minutes between removing the bag from the water and removing the fillet of fish from the bag;
the instructions include placing 8 cups of the water in the container; and
the fish or the fillet of fish is treated with moisture enhancing ingredients prior to the freezing.
